(19) United States
(12) Patent Application Publication
(10) Pub. No.: US 2006/0112133 A1
(43) Pub. Date: May 25, 2006

(54) System and method for creating and maintaining data records to improve accuracy thereof

(76) Inventors: Philip A. Ljubicich, Lake Forest Park, WA (US); David W. Camarillo, Portland, OR (US); Pankaj Kumar, Seattle, WA (US)

Correspondence Address: BRANDON N. SKLAR;c/o Kaye Scholer LLP, 425 Park Avenue, New York, NY, 10022, US

(21) Appl. No.: 11/259,986

(22) Filed: Oct. 26, 2005

Related U.S. Application Data
(63) Continuation-in-part of application No. 09/992,987, filed on Nov. 14, 2001, now Pat. No. 6,970,880.
(60) Provisional application No. 60/712,996, filed on Aug. 31, 2005.

(51) Int. Cl. G06F 17/00; G06F 7/00

(52) U.S. Cl. 707/102

(57) ABSTRACT

In one example, a system receives, from different sources, data having various formats, the received data is selected and combined in accordance with the invention to create accurate records. Specifically, the inventive system organizes the received data into uniform data records having a predetermined format. The data in the uniform data records is converted, if necessary, to conform to a predetermined nomenclature, resulting in normalized data records. The normalized data records are then processed to extract and/or deduce information desired by users.

This application claims the benefit of U.S. Provisional Application No. 60/712,996, which was filed on Aug. 31, 2005, and this application is a continuation-in-part of U.S. application Ser. No. 09/992,987, which was filed on Nov. 14, 2001. Both applications are assigned to the assignee of the present invention and are incorporated by reference herein.

### BACKGROUND OF THE INVENTION

The invention relates to a system and method for creating and maintaining data records. More particularly, the invention relates to a system and method for processing data from different sources which is in various formats to create records.

It is a common experience to call a telephone operator at a call center for information assistance. In a typical information assistance call, a customer identifies to the operator the name and address of a party whose telephone number is desired. In response, the operator locates the desired destination number using a computer database and the destination number is provided to the customer.

Typically, the computer database includes data from various data providers. These data providers may be telecommunication companies, such as Pacific Bell, GTE, or AT&T, to name a few. The data usually includes records having listing names, addresses, and telephone numbers of individuals and businesses throughout the United States and other countries. When processing millions of records (e.g., telephone listings) the reliability of the records becomes an issue. For example, a 5% error rate in data, comprising 140,000,000 records, yields 7,000,000 erroneous records. Since each data provider submits similar data, combining data from the various data providers is useful in creating accurate records. However, combining data is not easy because each data provider uses a different data format and the quality of data varies from provider to provider. Often data among the various data providers is inconsistent. For example, data representing a listing Diana Elizabeth Nicholls of 20 West 64TH Street from one data provider may look like Nicholls, Diana E. of 20 W 64th St from another data provider. Even though these listings represent the same person, the differences in format and nomenclature make it difficult for a computer database to determine whether the listings represent the same person or entity, and to combine and compare data. Accordingly, there is a need for a technique for processing data having various formats, which effectively selects and combines the data to create accurate records.

There is a further need for a service which extracts desired information from historical directory listing information. For example, we recognize that so-called “change of address information” can be used for identity verification purposes—the more someone moves, the fewer the number of other people there will be that know all of the details of where they lived and when. In addition, vendors who have not been paid may wish to obtain the current location of deadbeats based on their last known addresses, and law enforcement officials may wish to know where a particular suspect lived on a specific date. Information other than directory listing information can also be processed, either in conjunction with the directory listing information or otherwise, to extract additional information. It is another object of the present invention to extract this and other types of information from the historical listings.

We have also recognized that, with intelligent processing, a good deal of information can be deduced from historical directory listings. For example, if a man and a women move in together and/or begin to share the same telephone number, there is a high percentage chance they are in a romantic relationship. If the last name field of the women's listing also changes such that it becomes or incorporates the man's last name, it is likely the two got married at about the time the listing changed. Information other than directory listing information can also be processed, either in conjunction with the directory listing information or otherwise, to deduce additional information. It is another object of the present invention to intelligently process historical listings to deduce desired information.

### SUMMARY OF THE INVENTION

In accordance with embodiments of the invention, after data (e.g., telephone directory listing data) in various formats is received from different sources (e.g., telecommunications companies), the data is organized into records having a predetermined format. The resulting data in the predetermined format is checked, and converted, if necessary, to conform to a predetermined nomenclature. Once the data in the records are in the predetermined format and in conformance to the predetermined nomenclature, the records are grouped into sets of potentially equivalent records. For example, each set pertains to a listing of a telephone directory. The actually equivalent records are then identified for each set. Data fields in the identified records in the set which are relatively accurate are selected to form a final record concerning the listing to which the set pertains.

In accordance with other embodiments of the invention, directory listing data is processed in order to extract and/or deduce desired information. In one preferred embodiment, the listings received from each data provider are consolidated such that (i) Adds and Deletes of the same listing are combined into a single record having an “activation date” of the date the Add listing became effective and an “expiration date” of the date the Delete listing became effective; and (ii) records containing non-substantive differences are combined in a single record. Because the object of this consolidation is to have, for each data provider, a single record which contains the time period (the time between the activation date and the expiration date) during which the substantive information contained in the record (e.g., name, address, telephone number) was accurate, we call this consolidation “temporal reduction.”

Further in accordance with one preferred embodiment, the temporally reduced records are used as vertices of a graph. In effect, a graph is created whereby, for example, each vertex contains the information from one temporally reduced directory listing. This is illustrated in FIGS. 1A and 1B. FIG. 1A depicts four directory listings (Directory Listing 1-Directory Listing 4), and FIG. 1B depicts these four directory listings as vertices. Note that in a preferred embodiment, other than assigning each listing record a vertex label, the records themselves do not have to be physically changed to convert them into vertices. Therefore, in some sense, FIG. 1B illustrates the concept that the records will be used as vertices.

The edges between these vertices are then formed. In a preferred embodiment, each edge represents a relationship between the two vertices it connects. For example, as shown in FIG. 1C, if Directory Listing 2 and Directory Listing 4 contain the same data in the First Name and Last Name fields, First Name and Last Name edges can be generated between the two vertices. Because in a preferred embodiment every edge is unidirectional, FIG. 1C shows a graph in which two unidirectional Last Name edges (11 and 13) and two unidirectional First Name edges (15 and 17) are created between Directory Listing 2 and Directory Listing 4. In this way, for example, when routines are employed to traverse the graph to find listings with the same last name, Directory Listing 4 will be reached from Directory Listing 2 over edge 11, and Directory Listing 2 will be reached from Directory Listing 4 over edge 13. Other edges representing virtually any types of relationships between vertices can also be generated. Once all of the edges have been created, a graph has been generated with the temporally reduced listings from all of the data providers as vertices and with edges representing relationships between these vertices. The advantage of forming a graph with this information is that, as described below, well known graph traversal techniques can be employed to extract or deduce desired information.

In a preferred embodiment, however, before employing such graph traversal techniques, the graph is first distilled. This is done by using only one vertex to represent listings received from different data providers that contain the same substantive information. For example, data provider 1 and data provider 2 may both be directory listing suppliers, in which event it would be expected that both will send listings which are substantively identical (or nearly identical). It is preferable to use only one vertex to represent such substantively similar listings. This can be done by employing rules to favor one data provider's listings over another's (e.g., when data provider A and data provider B supply listings with the same substantive information, data provider A's listings will be kept in the graph and data provider B's listings will be removed), or in any other way. However the one vertex is selected or generated, other vertices containing the same listing information are then removed from the graph, as are all edges to and from them.

Once the graph has been distilled, graph traversal rules and techniques can be employed to generate subgraphs containing vertices (listings) having desired relationships. To take just one simple example, if an information assistance provider employing the invention plans to support a service to provide subscribers with the history of listing information for named individuals, subgraphs might be generated of vertices having Last Name and First Name edges between them (employing the assumption that if the last and first names are the same, it is the same person). Such a subgraph, generated from the graph of FIG. 1C, is depicted in FIG. 1D. The generated subgraphs are stored in searchable form in one or more databases.

These and many other aspects and embodiments of the instant invention are described in more detail in the Detailed Description below.

### BRIEF DESCRIPTION OF THE DRAWINGS

FIG. 1A is a representation of four directory listings;

FIG. 1B is a representation of the four directory listings of FIG. 1A as vertices of a graph;

FIG. 1C depicts the graph of FIG. 1B with edges between certain of the vertices;

FIG. 1D is a subgraph generated from the graph of FIG. 1C;

FIG. 1E is a block diagram of a system for creating and maintaining data records in accordance with the invention;

FIG. 2 illustrates a relational database structure for the normalized database of FIG. 1E;

FIG. 3 illustrates a data flow diagram of the front end of the system of FIG. 1E;

FIGS. 4A and 4B illustrate source data records from data providers;

FIGS. 4C and 4D illustrate uniform data records in a predetermined format;

FIGS. 4E and 4F illustrate normalized data records;

FIG. 5 illustrates a data flow diagram of the application interface of the system of FIG. 1E;

FIG. 6 illustrates a table for converting various names in accordance with a predetermined nomenclature;

FIG. 7 illustrates a data flow diagram of the back end of the system of FIG. 1E; and

FIG. 8 is a flowchart of a process carried out in the system of FIG. 1E;

FIGS. 9A and 9B illustrate an example of raw data that might be received from two hypothetical data providers (Provider A and Provider B), respectively;

FIGS. 10A and 10B illustrate the raw data of FIGS. 9A and 9B, respectively, after it has been through a conversion process;

FIGS. 11A and 11B illustrate the converted data of FIGS. 10A and 10B after it has been through a normalization process;

FIGS. 12 and 13 illustrate a flowchart of a temporal reduction process;

FIG. 14 illustrates the normalized data of FIGS. 11A and 11B after it has been through a first phase of a temporal reduction process;

FIG. 15A illustrates a hypothetical subset of Post Office directory listings;

FIG. 15B illustrates the listings of FIG. 15A with associated fuzzy telephone numbers;

FIG. 16 illustrates the data of FIG. 14 after it has been through a second phase of a temporal reduction process;

FIG. 17A and FIG. 17B illustrate the data of FIG. 16 after it has been through a vertex labeling process;

FIG. 18 illustrates the data of FIG. 17A and FIG. 17B after it has been through an edge generation process;

FIGS. 19A-19D diagrammatically illustrate the edges of FIG. 18;

FIGS. 20A and 20B illustrate the data of FIG. 17A, FIG. 17B, and FIG. 18 after it has been through a distillation process;

FIGS. 21A-21C diagrammatically illustrate the distilled data of FIG. 20A and FIG. 20B.

FIGS. 22A-22E diagrammatically illustrate subgraphs created with the distilled data of FIG. 20;

FIG. 23 illustrates the subgraph data of the subgraph diagrammatically illustrated in FIG. 22D.

FIG. 24 illustrates a user interface generated by a database front end;

FIG. 25 illustrates a user interface for entering a name of an individual whose move history is desired;

FIG. 26 illustrates a format for display of move history search results.

### DETAILED DESCRIPTION

The invention is directed to a system and method for processing data in order to extract and/or deduce desired information, and for processing data from different sources which is in various formats to create records.

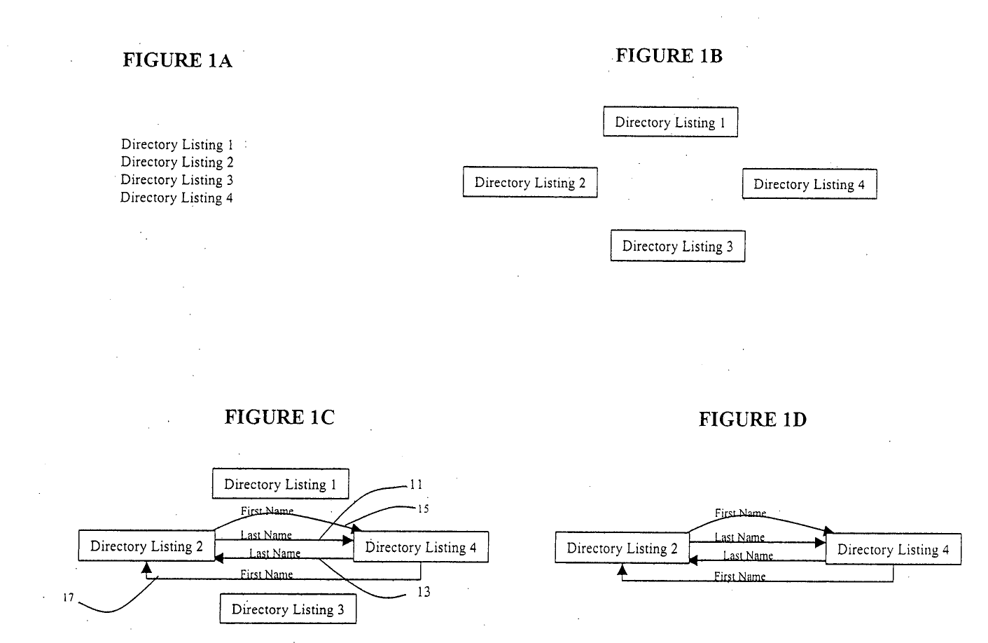

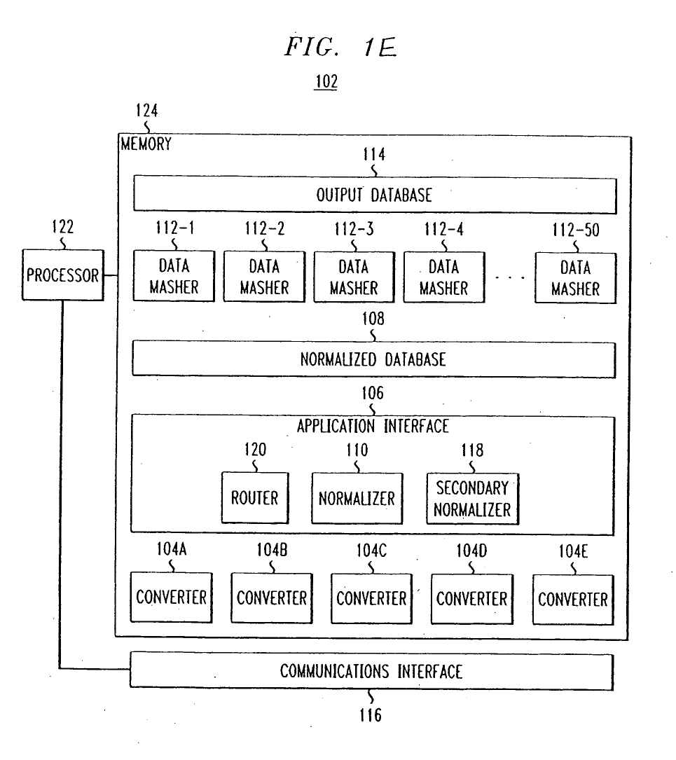

FIG. 1E is a block diagram of system 102 which embodies the principles of aspects of the invention. After receiving source data having various formats from different sources or data providers, system 102 selectively combines the source data into a database containing records in accordance with the invention. System 102 also provides the capability of adding and deleting records in the database, without having to reprocess all of the data.

System 102 may be a computer, for example, a PC type computer, which is capable of communicating with data providers over the Internet, intranet, and other networks. As shown in FIG. 1E, system 102 includes processor 122, memory 124, and communications interface 116. Memory 124 contains, among others, converter routines 104A-104E, application programming interface (API) routine 106, normalized database 108, data masher routines 112-1 through 112-50, and output database 114.

In this instance, the data providers are telecommunication companies such as AT&T, GTE, and Pacific Bell. The source data includes records that are used by an information assistance system. For example, the source data can include names, addresses, and telephone numbers of people in various regions of the country or world. It should be realized that system 102 can provide service concurrently to many computers, such as those operated by data providers and information assistance providers.

Operationally, various data providers send large amounts of source data, via a computer network, to system 102. For example, converter routines 104A-104E within system 102 convert the source data, from the various data providers, to a predetermined format to form uniform data, in a manner described below. Instructed by converter routines 104A-104E, system 102 combines source data from the various data providers to create records for use in, for example, the well known information directory assistance service. Additionally, system 102 provides the capability of adding and deleting records, without having to reprocess all of the uniform data. In general the routines in system 102 comprise computer-executable code (i.e. processing instructions), which are used to build a database of records, and add and delete one or more records in the database. The routines are stored in memory 124 generically representing here one or more computer memories such as floppy disks, hard disks, CD-ROMs, Flash RAMs, other ROMs and RAMs, or a combination thereof.

Communications interface 116, which is conventional, connects system 102 to data providers' computers, for example, via the Internet, pursuant to the well-known transmission control protocol/Internet protocol (TCP/IP). Communications interface 116, includes multiple data channels for receiving the source data from the various data providers. The received source data is processed according to their corresponding converters routines 104A-104E in a manner described below. Communications interface 116 also includes a standard interface with various information assistance systems. It should be realized that data from the various data providers can be downloaded into system 102 via CDROM, floppy disks, tape, and/or other high and low density storage mediums, or in any other manner.

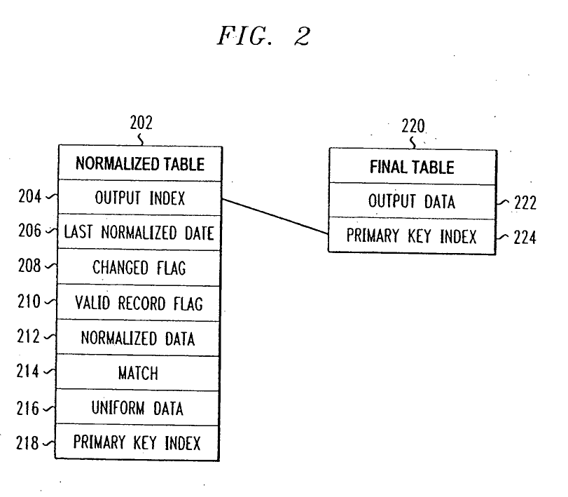

Normalized database 108 includes, for example, a relational database, e.g., MySQL, Oracle8i, etc., which is capable of creating and running queries, adding rows, creating tables and new users, modifying data, exporting or importing data, storing and reading data in a table format, creating and writing reports and macros, to name only a few functions. To manage the large amount of source data, normalized database 108 is sectioned into 50 normalized tables corresponding to 50 States in the United States. It should be realized that sectioning the normalized tables into States is for convenience and that database 108 can be sectioned differently, if sectioned at all. It should also be realized the particular number of normalized tables and States is for illustrative purposes and the number of tables can be increased, for example, to include representation of the provinces of Canada. FIG. 2 illustrates Normalized Table 202, which maintains source data from the various data providers that are associated with a State.

Like normalized database 108, output database 114 includes in one embodiment a relational database, e.g., MySQL, which is sectioned into tables corresponding to 50 States in the United States of America. FIG. 2 also illustrates a Final Table 220, which maintains output data that is associated with a State. Again, it should be realized that sectioning the tables into States is for convenience and that output database 114 can be sectioned differently, if at all. Indeed, in another embodiment, the normalized and output databases each may comprise, e.g., 200 “buckets” for containing data in an evenly distributed manner. For example, these buckets are identified by different hash codes, and each data content in a bucket is labeled with the hash code identifying the bucket.

It should be realized that databases 108 and 114 are illustrated separately, but may be combined into one database or expanded to three or more databases. Indeed, while memory 124 is described herein as comprising several different databases in accordance with preferred embodiments, any number of databases and/or storage schemes can be used, all of which are within the scope of the instant invention. Normalized database 108 and output database 114 reside in memory 124 and are coupled to the other modules, such as API routine 106, data masher routines 112-1 through 112-50, converter routines 104A-104E, and communications interface 116, by communication busses within system 102.

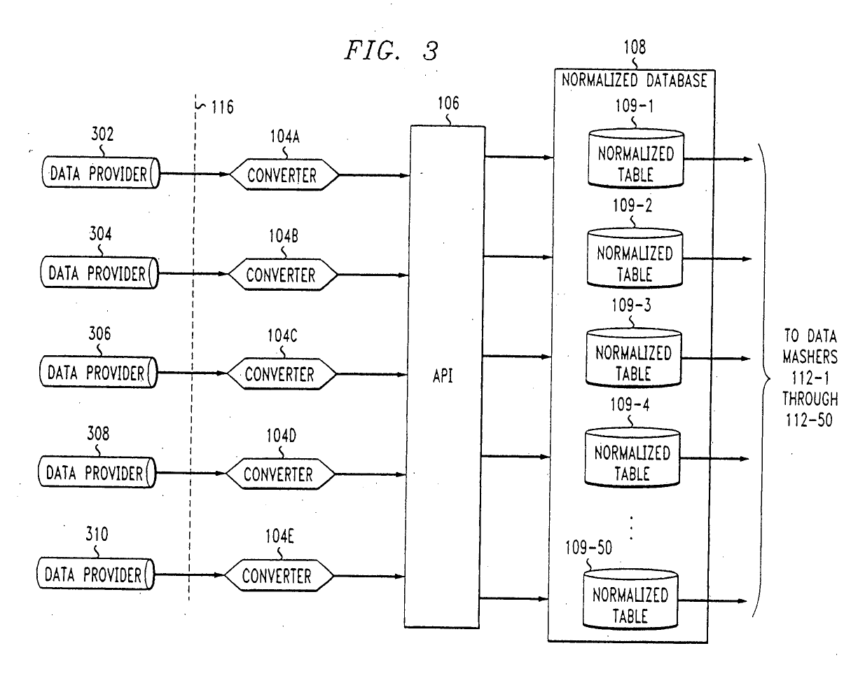

FIG. 3 is a data flow diagram of the front end of system 102. In this particular illustrative embodiment, converter routines 104A-104E are specifically designed to interface, via communications interface 116, with data providers 302-310, respectively. It should be realized that a skilled artisan could combine the five converter routines (104A-104E) into a single routine. It should also be realized that more or less than five data providers and converter routines can be implemented in system 102. Instructed by converter routines 104A-104E, processor 122 receives source data from data providers 302-310 connected to system 102 and convert the source data into uniform data having a predetermined format (hereinafter referred to as a “uniform format”). Because the source data is from various data providers, the organization of the source data often differs from one data provider to another. As a result, the organization of source data records and data within tables often differ from one data provider to another. To accommodate for the differences in the organization of source data, each converter routine 104A-104E is used to separate, rearrange, and/or combine source data into the uniform format including uniform tables and fields.

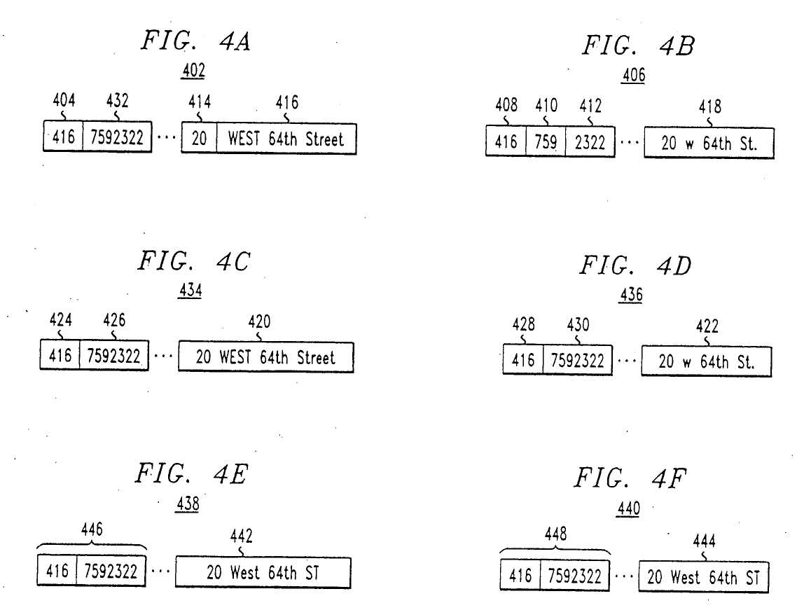

The data providers from time to time send source data arranged in a nonuniform format, such as, city name, telephone number, listing name, address, facsimile numbers, URLs, etc. For example, data provider 302 may provide source data record 402 having a telephone number in two telephone number fields 404, 432, as shown in FIG. 4A. On the other hand, data provider 304 may provide source data record 406 in FIG. 4B having the same telephone number in three separate telephone number fields, namely, field 408 containing a number plan area (NPA) (also known as an area code), field 410 containing a three-digit prefix, and field 412 containing the remaining four digits. In addition, data provider 302 may provide source data record 402 having address fields structured with house number and street name in separate fields 414 and 416, respectively, while data provider 304 may provide source data record 406 having a single address field 418 with fields having the complete address.

Source data records 402 and 406 are processed using the respective converter routines to form the corresponding uniform data records 434 in FIGS. 4C and 436 in FIG. 4D both in the uniform format. By way of example, the uniform format in this instance is such that all address information is arranged in a single address field. To that end converter routines 104A-104E arrange all address data in a source data record that is not in a single address field, e.g., fields 414 and 416 in record 402, into a single address field in uniform data record, e.g., field 420 in record 434. However, the address information, which has already been arranged in a single address field, such as field 418 of source data record 406, it does not have to be changed because it is already consistent with the uniform format and can be directly transferred to field location 422. In addition, the uniform format in this instance requires that a telephone number in a source data record be arranged in two telephone number fields in a uniform data record, e.g., fields 424 and 426 in record 434, and, e.g., fields 428 and 430 in record 436. To that end, converter routines 104A-104E rearrange the data into two fields, such as in fields 428 and 430. If the data provider 302 provides source data having telephone numbers in two telephone number fields 404 and 432, then converter routine 104A-104E will not rearrange the telephone numbers, such as in the case of telephone number fields 424 and 426. The resulting uniform data records are stored in Uniform Data location 216 in FIG. 2. In an alternative embodiment, the uniform format may require that the telephone number data be arranged into three telephone number fields, e.g., an area code field, a prefix field and a last-four-digit field. In that embodiment, the telephone number in fields 408, 410 and 412 of source data record 406 is already in the uniform format and thus no rearrangement thereof is necessary.

In addition, converter routines 104A-104E instruct processor 122 to assign predetermined field identifiers to the uniform data record fields 424, 426, 420, 428, 430 and 422. The predetermined identifiers indicate the order of which the fields are arranged in Uniform Data location 216 and in Normalized Data location 212, after the uniform data is normalized in a manner described below.

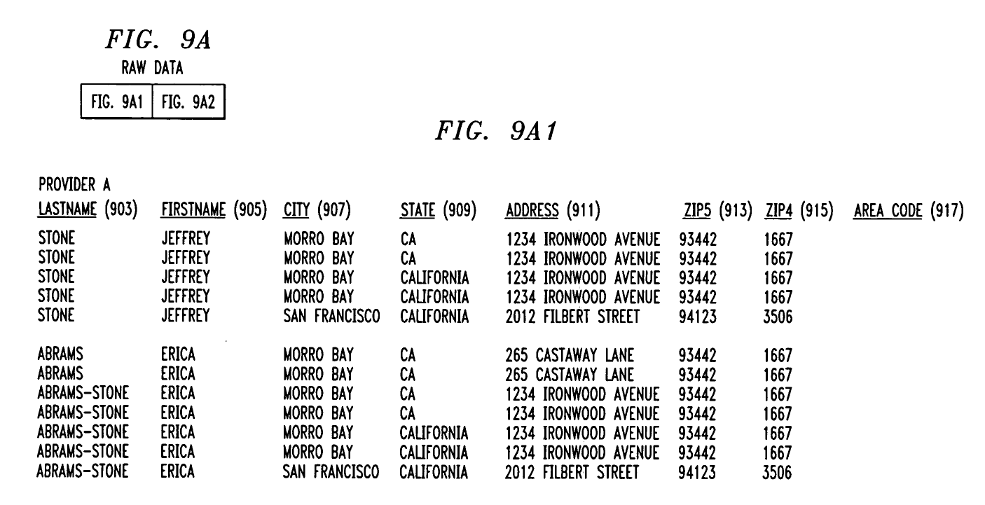

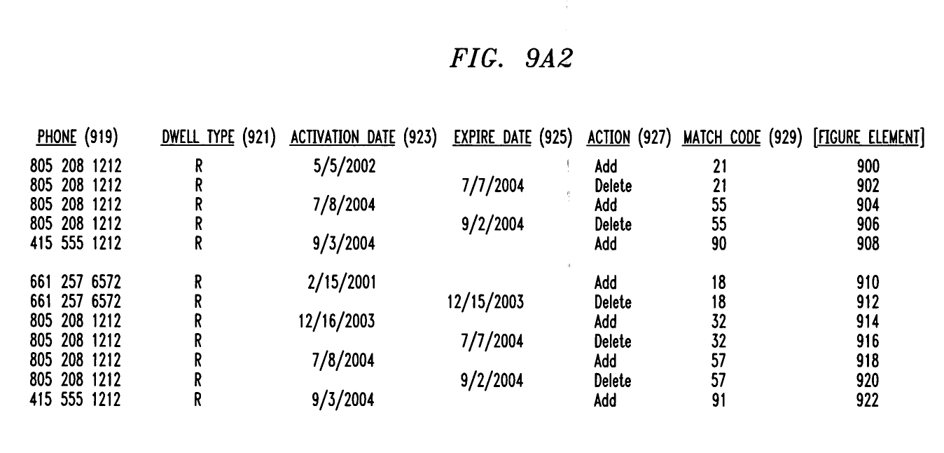

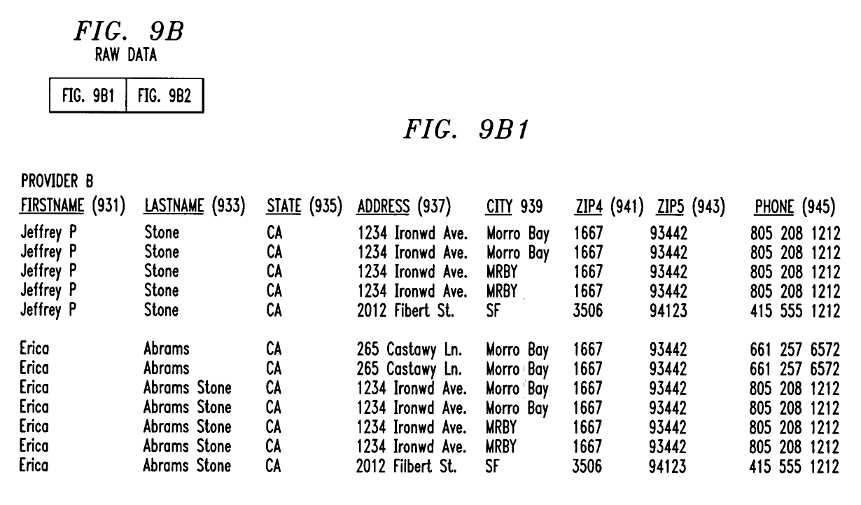

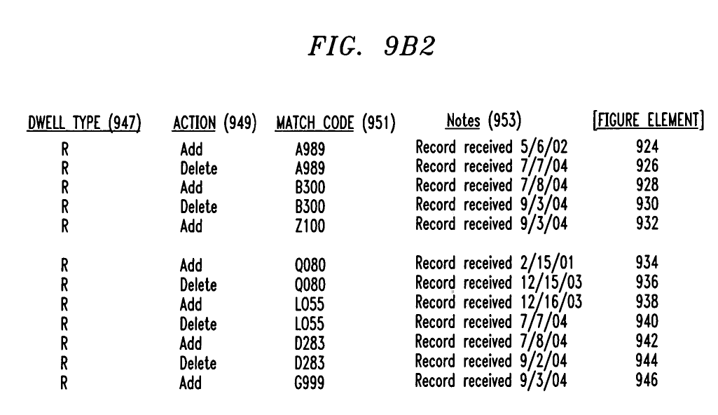

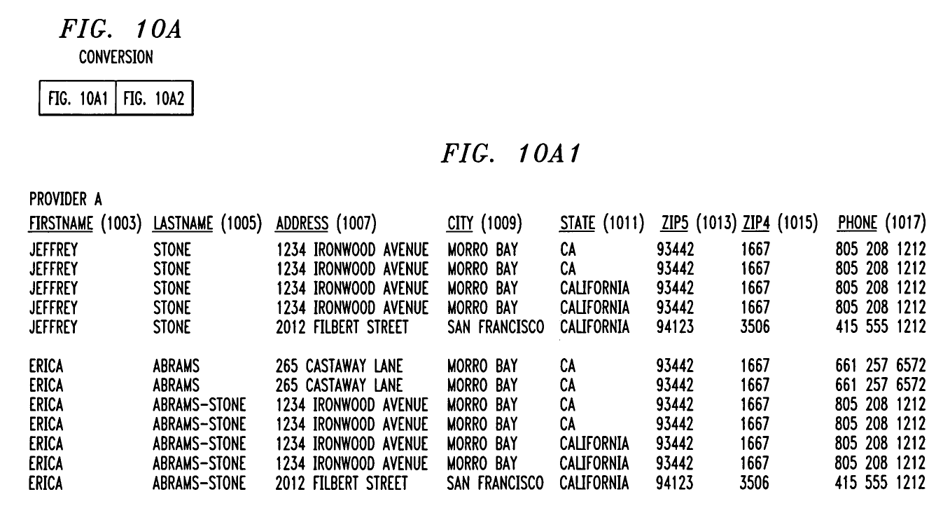

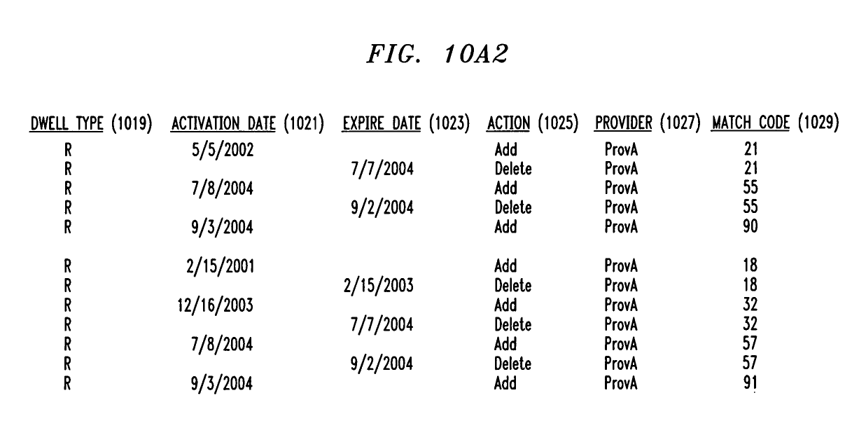

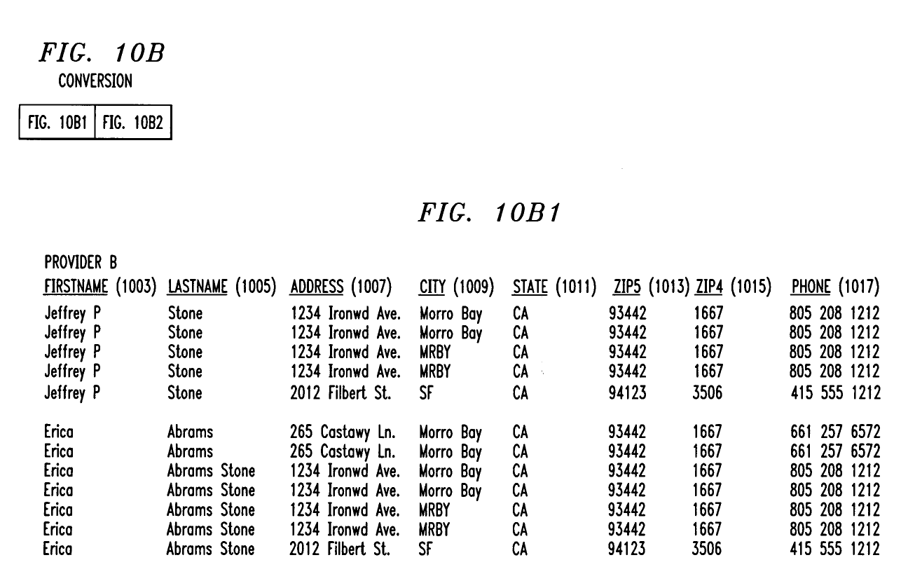

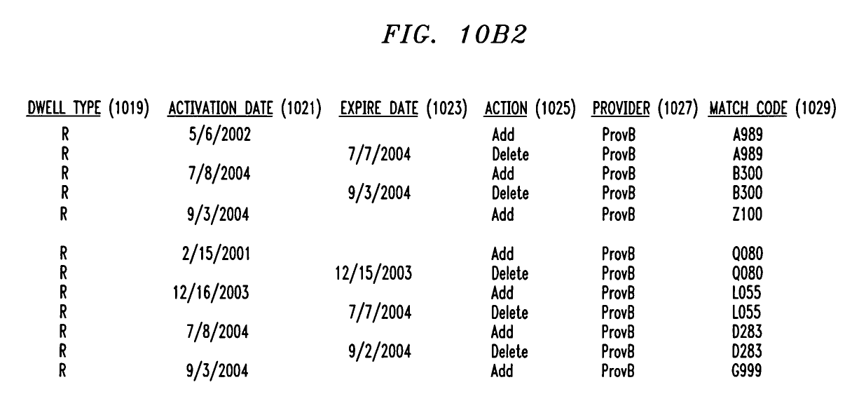

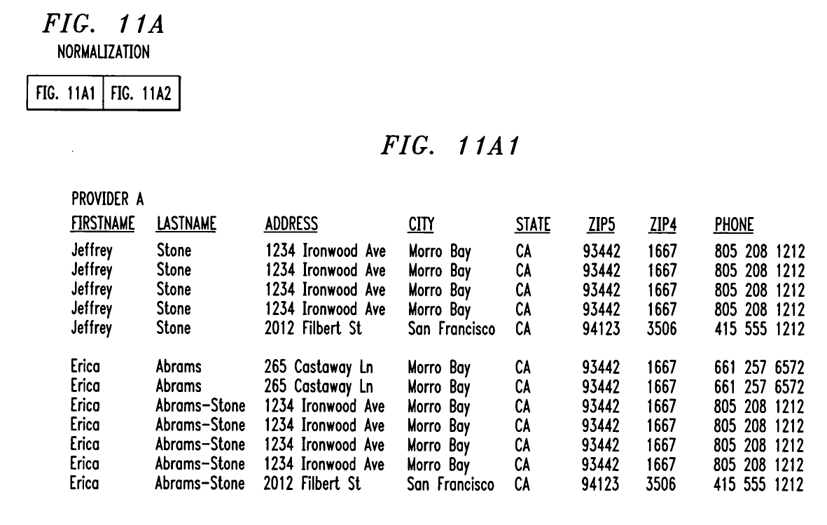

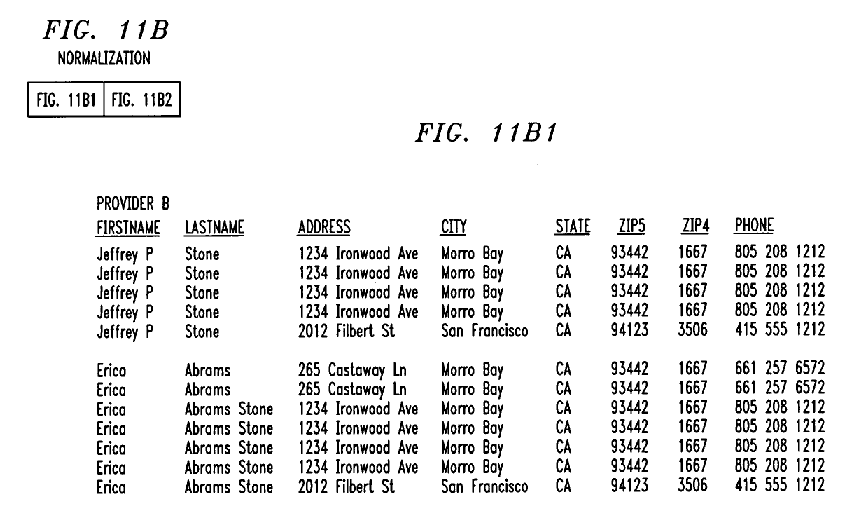

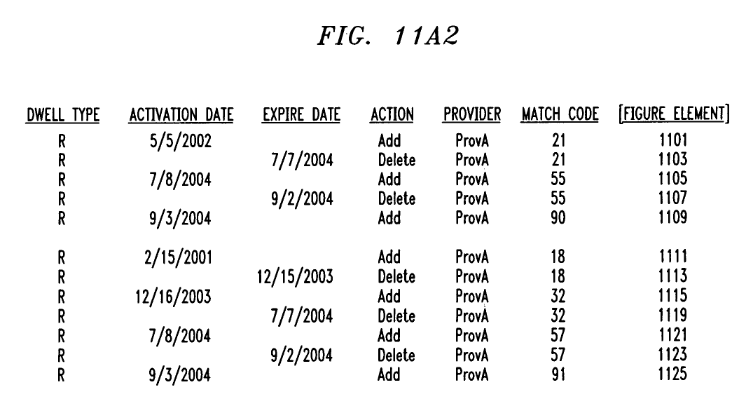

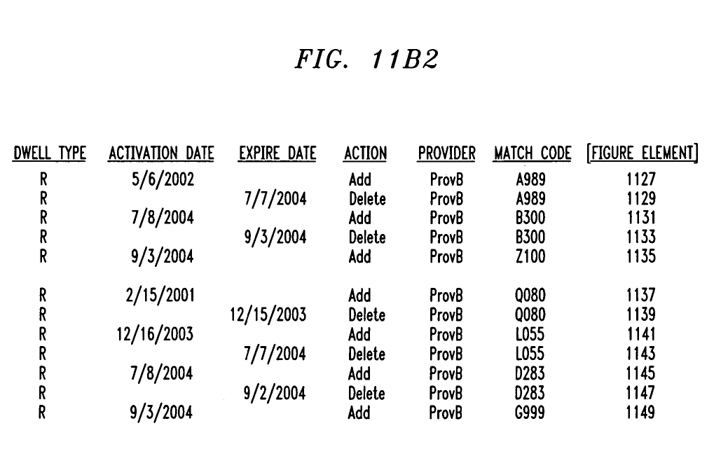

The function of converter routines 104A-104E when applied to the raw data received from the different data providers is further illustrated in FIGS. 9A, 9B, 10A and 10B. FIGS. 9A and 9B depict the raw listing information for “Jeffery Stone” and “Erica Abrams” (who later changed her name to “Erica Abrams-Stone”) received over time from two different hypothetical data providers (“Provider A” and “Provider B”). FIGS. 10A and 10B depict this raw data after it has been processed by converter routines 104A-104E.

As shown in FIG. 9A, listings received from Provider A contain the following fields, in order: (1) last name of the listed party, denoted 903; (2) first name of the listed party, denoted 905; (3) city in which the listed party resides, denoted 907; (4) state in which the listed party resides, denoted 909; (5) listed party's street address, denoted 911; (6) first 5 digits of the zip code (the traditional zip code), denoted 913; (7) final 4 digits of the zip code (for “zip +4” format), denoted 915; (8) area code of the listed party's telephone number, denoted 917; (9) final seven digits of the listed party's telephone number, denoted 919; (10) dwelling type (e.g., “Residential,” “Business” or “Government”), denoted 921; (11) activation date of the listing, denoted 923; (12) expiration date of the listing, denoted 925; (13) the action to be taken with respect to the listing (e.g., “Add” the associated listing or “Delete” the associated listing), denoted 927; and (14) the “match code” of the listing, denoted 929. Match codes associate respective adds and deletes of the same listing. That is, in order to delete a previously added listing, the data provider sends the listing again with the action field of the listing set to “Delete.” The Delete listing is associated with the previous Add listing with the match code, which will be identical for the two listings. Match codes can take different forms, depending on the data provider.

Listings from Provider B, shown in FIG. 9B, contain the following fields, in order: (1) first name of the listed party, denoted 931; (2) last name of the listed party, denoted 933; (3) state in which the listed party resides, denoted 935; (4) listed party's street address, denoted 937; (5) city in which the listed party resides, denoted 939; (6) final 4 digits of the zip code, denoted 941; (7) first 5 digits of the zip code, denoted 943; (8) the listed party's ten digit telephone number, denoted 945; (9) dwelling type, denoted 947; (10) the action to be taken with respect to the listing, denoted 949; and (11) the match code, denoted 951. Note that Provider B does not include activation dates or expiration dates with its listings, and neither Provider A nor Provider B supply data in the listings to indicate that it was the data provider that sent the listings.

FIGS. 10A and 10B illustrate the raw data of FIGS. 9A and 9B, respectively, after it has been processed by converter routines 104A-104E. That is, the data is in a uniform format employed by, for example, an information assistance provider using the instant invention to provide services to its customers. In this example, the uniform format consists of the following fields, in order: (1) first name of the listed party, denoted 1003; (2) last name of the listed party, denoted 1005; (3) listed party's street address, denoted 1007; (4) city in which the listed party resides, denoted 1009; (5) state in which the listed party resides, denoted 1011; (6) first 5 digits of the zip code, denoted 1013; (7) final 4 digits of the zip code, denoted 1015; (8) the listed party's ten digit telephone number, denoted 1017; (9) dwelling type, denoted 1019; (10) activation date of the listing, denoted 1021; (11) expiration date of the listing, denoted 1023; (12) the action to be taken with respect to the listing, denoted 1025; (13) the data provider which provided the listing, denoted 1027; and (14) the match code, denoted 1029. The converter routines associated with Provider A and Provider B convert the listings received from these providers into the uniform format.

In order to populate all of these uniform fields with respect to listings from Provider A and Provider B, however, the converter routines are capable of obtaining and/or deducing information not supplied by the providers themselves. For example, as noted above, neither Provider A nor Provider B supply data in the listings to indicate that it was the data provider that sent the listings. Therefore, the converter routines add this information. In a preferred embodiment, where a different converter routine is used for each different data provider, this is a relatively straightforward task. However, as noted above, the present invention does not require that a different converter routine be used for each data provider, and those skilled in the art will appreciate that there are a number of ways a converter routine can determine which data providers sent which listings in other embodiments of the present invention.

The converter routine associated with Provider B in this example also populates the activation date and expiration date fields for Provider B's listings. In a preferred embodiment, this is done by populating the “activation date” field with the date the listing was received from Provider B if the action field indicates an “Add,” and by populating the “expiration date” field with the date the listing was received from Provider B if the action field indicates a “Delete” (for ease of understanding, the date Provider B's listings were received is indicated in the “Notes” column in FIG. 9B, denoted 953, although it will be appreciated that the raw data does not actually contain this information).

Those skilled in the art will appreciate that alternate embodiments of converter routines can be employed to convert raw data received in virtually any format, that virtually any uniform format can be used, and that many other fields can be populated by converter routines when they are not supplied by data providers, and that all such embodiments are within the scope of the instant invention. Moreover, although in a preferred embodiment the converted data is stored in pipe-delimited ASCII format, the converted data can be stored in virtually any format in accordance with the principles of the instant invention. As will be appreciated from the discussion below, converting the data into a uniform format allows downstream processes to treat data received from different data providers uniformly.

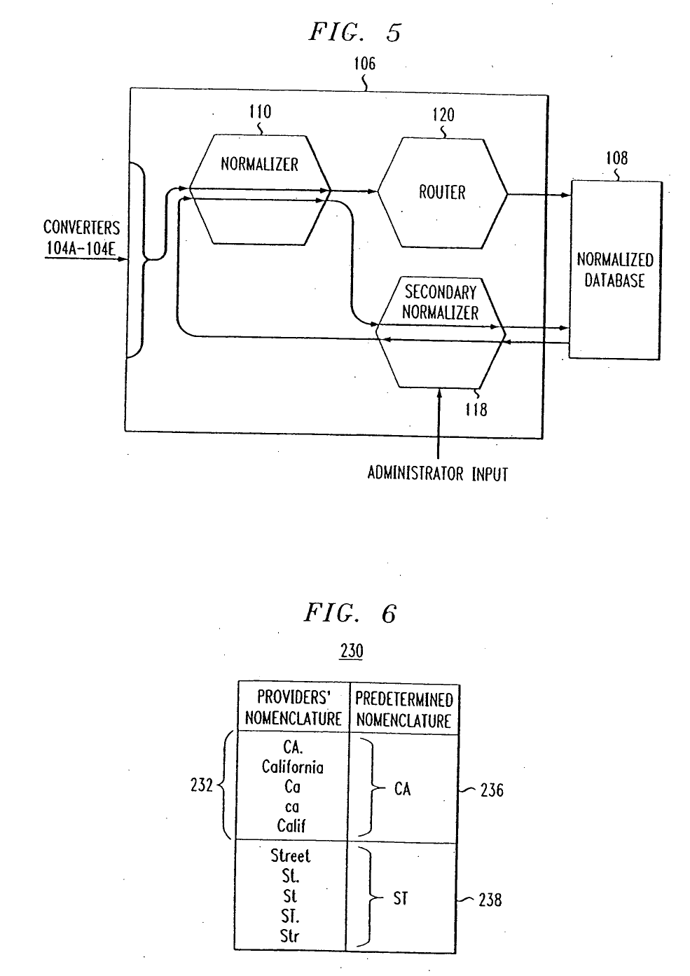

FIG. 5 illustrates a data flow diagram of API routine 106, which includes additional routines such as normalizer routine 110, secondary normalizer routine 118, and router routine 120. API routine 106 instructs processor 122 to configure an instance to process uniform data attributed to each data provider. For example, a first instance is associated with the Pacific Bell source, a second instance is associated with the GTE source, and a third instance is associated with the Southwestern Bell source. Because in this example there are five converter routines (converter routines 104A-104E), there can be up to five instances operating in API routine 106. Of course, use of five converter routines here are for illustrative purposes and the number of instances can vary.

Additionally, API routine 106 instructs processor 122 to add or delete one or more new uniform records and accordingly set one or more status flags in normalized database 108. For example, instructed by API routine 106, when processor 122 receives one or more new uniform records from the converter process, processor 122 sets the status of a Changed Flag in location 208 to “Yes”. The status “Yes” indicates that a new uniform record has been added or deleted. Similarly, when processor 122 adds or deletes one or more normalized records, processor 122 sets the status of the Changed Flag to “Yes”. API routine 106 also instructs processor 122 to communicate to one or more data masher routines 112-1 through 112-50, or other downstream routines in other embodiments, the need to either add or delete the record, which is described in detail below.

Each source record from a data provider includes an identifier, which is unique to the source record and is provided by the data provider. Because the data provider may use the same identifiers every time it sends source records to system 102, processor 122 assigns its own series of identifiers, namely, primary key indexes, to the source records so that the new source records can be distinguished from the previous source records. In this instance, a primary key index, e.g., a 64-bit value, is used for indexing, updating and searching for source, uniform and normalized data records. The primary key indexes are stored in location 218.

After a particular data provider sends new source data and it is converted to uniform data, processor 122 queries normalized database 108 for the largest primary key index value in location 218 associated with the particular data provider. Once the largest index value is identified, new uniform data records are stored in uniform data location 216 in association with new indexes, having sequentially higher values than the identified largest index value. Thus, any data attributed to the particular data provider that has an index value less than or equal to the identified largest index value represents previous data, which may in some embodiments be deleted if so desired. Of course, if historical listings analysis (described below) is to be done, it is desirable to retain as large a history of listing data as possible.

Instructed by router routine 120, processor 122 routes all of the uniform data and normalized data to the appropriate Normalized Table 202 based upon which State the record is associated with. The data in the State field within the normalized record identifies which State the record is associated with and which one of normalized tables 109-1 through 109-50 in FIG. 3 to store the normalized data.

Normalizer routine 110 is used to convert uniform data to normalized data in accordance with a predetermined nomenclature. This stems from the fact that the various data providers 302-310 often provide data of similar type in different nomenclatures. For example, one data provider may provide data representing the State of California as “Ca” and a second data provider may provide data representing the State of California as “California”. Because this data may be used later on in a comparison process, it is converted to conform to the predetermined nomenclature, such as “CA”.

FIG. 6 illustrates conversion table 230 for conversion of data in data providers' nonuniform nomenclatures to that in the predetermined nomenclature. Take State data type 232 for example. The State name “California” may be represented by different data providers as “CA.”, “Ca”, “ca”, California, or “Calif”. In another example, “Street” may be represented by different data providers as “St.”, “Street”, “st”, “ST.” or “Str.” As shown by rows 236 and 238 of table 230, normalizer routine 110 instructs processor 112 to convert various representations of “California” and “Street” to normalized data “CA” and “ST”, respectively, in accordance with the predetermined nomenclature.

Generally, normalizing data involves reading uniform data, checking for conformity among the uniform data and, where necessary, converting the uniform data into the predetermined nomenclature. Normalizer routine 110 instructs processor 122 to read the uniform data and separate the uniform data into components, to prepare the uniform data for changes and conversion to normalized data. Processor 122 may separate an address into components representing a house or building number, street name, street type, apartment number, etc.

Referring back to FIGS. 4C and 4D, uniform data record 434 has an address 20 WEST 64th Street, which is separated into the following components (A) 20 (B) WEST (C) 64th (D) Street. Although uniform data record 436 has the same address, it is indicated as 20 w 64 TH St., which is similarly separated into components: (A) 20 (B) w (C) 64 TH (D) ST. The separated components may be converted to conform to the predetermined nomenclature, if necessary. The conversion may include substituting words (abbreviations) and correcting words (correcting abbreviations), resulting in normalized data records 438 and 440 in FIGS. 4E and 4F, respectively. Thus, for example, the addresses in address fields 442 and 444, which conform to the same predetermined nomenclature, are now identical. In this example, the telephone numbers in fields 424 and 426 in uniform data record 434, and those in fields 428 and 430 in uniform data record 436, do not have to be normalized because they already conform to the predetermined nomenclature and are directly transferred to fields 446 and 448 in the respective normalized data records.

Additionally, normalizer routine 110 may instruct processor 122 to remove extensions from the end of telephone numbers. Extensions can be a phone number (alpha or digit) and anything from 1 to 4 digits, ignoring white space. The telephone number is analyzed and checked if it contains letters that need to be substituted for numbers. If a letter substitution would yield a reasonable telephone number and 1 to 7 letter substitutions would yield 7 total digits, then the substitutions are performed, otherwise the record is considered invalid.

After the telephone numbers are normalized, API routine 106 can also instruct processor 122 to perform NPA splits. For example, a telecommunications carrier may change an area code in whole or in part, or change the area code for half of telephone numbers in a State to a new area code. In the example where they change the area code of half the telephone numbers in a State, the data provider can send to system 102 a file of NPAs that are changed. The normalized data records containing the changed area codes are added to Normalized Data location 212 and eventually reprocessed by processor 122, in accordance with instructions from a data masher routine.

In addition, the normalized data records are checked for validity. Each normalized data record in Normalized Data location 212 is associated with a Valid Record Flag in location 210, which indicates whether a particular normalized data record is valid or invalid. API routine 106 instructs processor 122 to query normalized database 108 to set the Valid Record Flags in location 210 to either “Yes” or “No.” For example, if a normalized data record has a 13-digit telephone number it is considered invalid and the associated Valid Record Flag is set to “No.” On the other hand, if the telephone number is 10 digits long, the associated Valid Record Flag is set to “Yes.” Thus, for example, when data masher routines 112-1 through 112-50 are processing normalized data records, invalid normalized data records are identified based on the statuses of the Valid Record Flags, and not included in the process.

Additionally, normalizer routine 110 may check normalized data records for accuracy. For example, telephone numbers and addresses can be checked for accuracy by cross-referencing the data with United States Postal Service (USPS) data. The USPS data is stored in normalized database 108.

Other examples of normalizing listing names involve normalizer routine 110 instructing processor 122 to perform various functions, such as camel-backing the listing, removing odd characters, and removing white space from the extremities of the listing name. Camel-backing is converting data that is in uppercase to lower case, while leaving the first letter in uppercase. It should be realized that normalization standards can change, and, for example, as problems with data are identified, normalizer routine 110 can be reconfigured to solve the problems and the data can be renormalized. The logic used by normalizer routine 110 to perform these functions is stored in a table in normalized database 108. Changing the logic in the table results in reconfiguration of normalizer routine 110.

Normalizing a city name may involves the city name being camel-backed, white space is removed or added, and odd characters are removed or added (e.g., for example A23 Ave@ or A23th Ave@ are both changed to read A23rd Ave@). The city name may also be broken apart into its city name and quadrant (if applicable). The quadrant can include N, S, E, W, NE, NW, SE and SW. ZIP codes are analyzed by determining whether the ZIP is 5 digits, or 4 digits.

Secondary normalizer routine 118 may be used to fix data within the records that were not normalized properly or that were not identified as needing normalization during the initial normalization process by normalizer routine 110. It should be realized that all data is reviewed for possible normalization, but occasionally a normalization problem is identified that requires renormalization of data. Secondary normalizer routine 118 includes the logic for instructing processor 122 to reconfigure the normalization process within normalizer routine 110 and for performing other tasks, such as querying normalized database 108.

Sometimes an error in the data is identified by information assistance personnel. After discovering one such error (e.g., an incorrect city abbreviation), the personnel notifies an administrator of system 102. Referring to FIG. 5, the administrator of system 102, via a user interface, can enter a reconfiguration scheme into system 102. Secondary normalizer routine 118 instructs processor 122 to reconfigure a configuration table with the reconfiguration scheme, and query the uniform data in Uniform Data location 216 that need to be renormalized. The routine instructs processor 122 to send the uniform data to normalizer routine 110 for renormalization. The uniform data is renormalized, which includes modifying uniform data that was not previously identified as requiring normalization. After the uniform data is renormalized into normalized data, the normalized data is stored in Normalized Data location 212.

Last Normalized Date 206 is a location that stores a date and time when a uniform data record was normalized by normalizer routine 110. Because the configuration of normalizer routine 110 can change, the date and time also represents the configuration version that normalizer routine 110 used when that uniform data record was normalized. Associating dates and times with uniform data records allows for secondary normalizer routine 118 to instruct processor 122 to query normalized database 108 for uniform data records based upon a selected date and time. For example, if data was changed on Oct. 23, 2001 at 7:35 AM, then all the uniform data records with a last normalized date before this date and time are normalized a second time. In situations where there is a need to change the normalization process and therefore renormalize all of uniform data, secondary normalizer routine 118 instructs processor 122 to query normalized database 108 to search location 216 for uniform data records having a last normalized date that predates the current normalized date, and instructs processor 122 to normalize such uniform data records.

Generally, when processor 122 normalizes the uniform data, it sets the Changed Flags in location 208 associated with the resulting normalized records to “Yes”, and updates the last normalized date in location 206 to the current date and time. It is anticipated that a data masher routine, say, routine 112-1 may later on instructs processor 122 to search normalized database 108 for the normalized data records having a Changed Flag set to “Yes,” and to further process them in a manner described below.

FIGS. 11A and 11B illustrate the normalized form of the converted data of FIGS. 10A and 10B, respectively. As shown in FIGS. 9A, 9B, 10A, and 10B, Provider A and Provider B use different nomenclature for the same information: 1) Provider A uses all uppercase characters while Provider B uses “initial caps” format (e.g., fields 903, 905, 907, 909 and 911 in FIG. 9A are populated with exclusively uppercase text while fields 931, 933, 935, 937 and 939 in FIG. 9B are populated with text in initial caps format); 2) Provider A uses “AVENUE,” “STREET” and “LANE” in the address fields (see the way field 911 in FIG. 9A is populated) while Provider B uses “Ave.”, “St.” and “Ln.” to represent this same information (see the way field 937 in FIG. 9B is populated); 3) Over time, Provider A has used both complete state names and state abbreviations (see the way field 909 in FIG. 9A is populated), while Provider B has consistently used only state abbreviations (see the way field 935 in FIG. 9B is populated); 4) Over time, provider B has used both full city names and city abbreviations (see the way field 939 in FIG. 9B is populated), while provider A has consistently used the full city names (see the way field 907 in FIG. 9A is populated); and 5) Provider B abbreviates street names (e.g., “Ironwd” for “Ironwood” and “Castawy” for “Castaway”) (see the way field 937 in FIG. 9B is populated) while provider A uses full street names (see the way field 911 in FIG. 9A is populated).

In this particular example, the uniform nomenclature employed by the information assistance provider is to use initial caps, full street names, full city names, and “Ave,” “St” and “Ln” (without concluding periods) for “Avenue,” “Street,” and “Lane” respectively. After normalization, then, the converted data of FIGS. 10A and 10B is in this uniform nomenclature as shown in FIGS. 11A and 11B. Because idiosyncrasies in the data representations have been removed, downstream processes can match data much more accurately. While normalized data can be stored in any number of ways, in a preferred embodiment it is stored in pipe-delimited ASCII format.

In a preferred embodiment, data is normalized, as described above, by establishing a discrete set of substitution patterns for different fields. For example, rules can be implemented such that, in the address field, “Ironwood” is always substituted for “Ironwd” and “Rosewood” is always substituted for “Rosewd”. However, normalization can also be done by substituting for regular expressions (e.g., always substitute “*wood” for “*wd”, where “*” is a metacharacter that matches any one character or any string of contiguous characters). Where possible, employing discrete sets of substitution patterns is preferred over the use of regular expressions, since the use of regular expressions can result in unintended erroneous substitutions.

Whether or not regular expressions are used, the substitution rules can be highly context sensitive. For example, a rule can be employed to change “Ironwd” to “Ironwood”, but only when the city is Morro Bay and the state is California. As those skilled in the art will appreciate, substitution rules can be employed which rely on many types of contextual information, including information contained in other field(s) for the same listing, field(s) in other listings from the same provider, field(s) in other listings from other providers, information not contained in any listings at all (e.g., substitution criteria can include the version of software being used), which data provider the listing is from, etc. The present invention is not limited to any particular normalization methods, all such methods being within the scope of the instant invention.

Note that, in a preferred embodiment, the name fields may not be normalized, because it is difficult to ascertain from names alone whether differences are in nomenclature or are substantive (i.e. they are actually the names of different people.) That is, the name fields may be normalized only if the names therein can be determined with a high level of certainty.

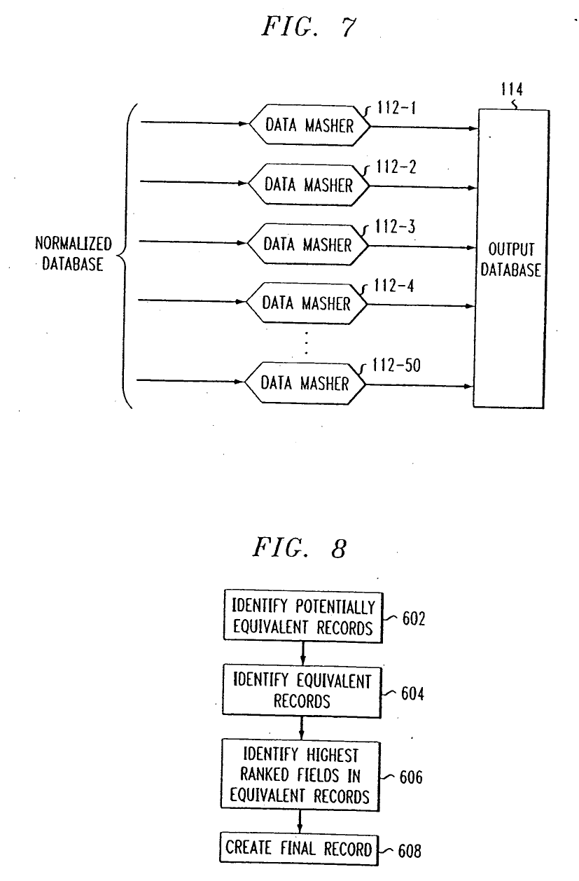

FIG. 7 illustrates a data flow diagram of the back end of system 102 in accordance with one embodiment of the invention. Instructed by data masher routines 112-1 through 112-50, processor 122 performs various functions, such as querying normalized database 108 for one or more sets of potentially equivalent normalized data records. For each one or more sets of potentially equivalent normalized data records, processor 122 (1) determines which of the potentially equivalent normalized data records within the sets are equivalent normalized data records (2) determines which of the fields from each of the equivalent normalized data records within the sets are accurate and (3) combines accurate fields within the sets into records. The records are then transferred to output database 114. It should be realized that data masher routines 112-1 through 112-50 may be combined into a single routine. In this illustration, 50 data masher routines are used to process data related to 50 states, respectively. In another embodiment, 200 data masher routines are used to process data distributed over 200 buckets, respectively.

FIG. 8 illustrates a generic data masher routine representing, say, data masher routine 112-1. Instructed by data masher routine 112-1, processor 122 at step 602 identifies one or more sets of potentially equivalent normalized data records. This is achieved by querying normalized database 108 to search data in Match location 214 for identical telephone numbers. Data in Match location 214 (e.g., telephone numbers) is associated with the records in Normalized Data location 212 and stored there for searching for normalized data records having matched data. The other fields in the normalized data records (e.g., the address fields) are analyzed by processor 122 to determine a confidence level value for each normalized data record, which is described in detail below.

At step 604, processor 122 determines whether the normalized data records within a set of potentially equivalent normalized data records are actually equivalent. Processor 122 makes such a determination in one embodiment by assigning a confidence level value to every normalized data record in the set. The confidence level is necessary because, for example, two normalized data records can have the same telephone numbers, states, listing names, zip codes, but different addresses. A field-by-field comparison of these two normalized data records would indicate that these records are different, when, in fact, the only difference between normalized data records is the address.

Confidence level values are assigned to the potentially equivalent normalized data records to determine whether the normalized data records are equivalent. For example, the higher the confidence level the more likely the normalized data records are equivalent and the more likely the fields will be shared to construct a record. Processor 122 compares each normalized data record within a set to the other normalized data records in the set, on a field-by-field basis, and determines whether the normalized data records are equivalent, based upon their confidence level values. Every time data within two similar fields are found to be identical, the confidence level increases. The greater count of identical fields, the higher the confidence level value. For example if four out of five fields are identical, then the confidence level value is four, which is considered high and, thus it is concluded that equivalent normalized data records exist.

It should be noted that in another embodiment, the field-to-field comparison of normalized data is enhanced by removing suffixes and prefixes of names, white spaces and street name ordinations, and by use of a SOUNDEX algorithm, which determines whether corresponding words in normalized data records are sound-equivalent. This stems from our observation that data providers may rely on voice recognition technology to perform source data entry. That is, the source data is entered based on a machine's recognition of a person's utterance thereof. For example, a town named “Sunnyvale” may have been incorrectly entered textually by a voice-to-text converter as “Sunnyveil” because of their identical pronunciation. Thus, by also using the SOUNDEX algorithm in the field-to-field comparison, the corresponding words from two normalized data records which would otherwise be considered different because of their textual differences may be considered the same when it is determined that they are sound-equivalent.

In addition, if normalized data from the address fields from two normalized data records are compared and it is determined that there is a difference between the data (e.g., “Sunnyvale” vs. “Sunnyveil”), the aforementioned USPS database may be cross-referenced to determine which normalized data is correct, which improves the accuracy of the record.

Data masher routine 112-1 utilizes a threshold level value for determining whether the confidence levels have reached a minimum level of acceptance. The threshold level value is a predetermined value that the confidence level values must equal or exceed for processor 122 to consider normalized data records equivalent. All the normalized data records within a set of potentially equivalent normalized data records that are determined to have confidence level values that equal or exceed the threshold level value are considered equivalent.

Once equivalent normalized data records are identified, at step 606 processor 122 identifies, for each data fields (or, alternatively, group of data fields), the highest ranked data field (group of data fields) of all the corresponding data fields (groups) in the equivalent records. In this instance, the highest ranked data field (group of data fields) is contributed by the data provider having the highest reliability ranking with respect to such a field (group). To that end, the data providers are ranked for each data field (group) in terms of their reliability with respect to the field (group). Such reliability rankings are based upon past ratings of the accuracy of data contributed by the respective providers to the field. The reliability rankings are stored in a table (not shown) in memory 124. For example, if a particular data provider is known for providing extremely accurate street names, fields with street names from this data provider are assigned a relatively high ranking associated therewith. If this same data provider is known for providing inaccurate city names, fields with city names from this data provider are assigned a relatively low ranking associated therewith.

Specifically, processor 122 retrieves the reliability rankings from the table, groups the fields and associated ranking values by “field type,” and selects the highest ranking value and associated normalized data for each “field type”. The “field type” refers to the category of the field, e.g., street name and city name. Thus, for example, processor 122 selects those normalized data in the street name field, the city name field, and other fields contributed by their respective highest ranked data providers. Processor 122 at step 608 combines the selected data to create a final record.

The final record is stored in Output Data location 222, and is assigned a primary key index in location 224. Each of the normalized data records contributing to the final record is assigned an output index which is the same as the primary key index of the final record, and which is stored in Output Index location 204. Accordingly, if an incorrect final record is identified in Output Data location 222, the contributing normalized data records can be readily determined by relating the primary key index of the incorrect final record to their same output index.

When a particular normalized data record is to be deleted, API routine 106 instructs processor 122 to query normalized database 108 to set the associated Changed Flag in location 208 to “Yes” and initiate data masher routine 112-1, removing the deleted normalized data record from consideration. Data masher routine 112-1 instructs processor 122 to perform steps 602-608 without contribution from the deleted normalized data record. This process yields a second final record that has data selected from one or more equivalent normalized data records, with no regard for the deleted normalized data record. This second final record may or may not be same as the previous final record. Processor 122 then sets the associated Changed Flag to “No,” and a new primary key index value is assigned to the second final record. The new primary key index and the second final record are stored in locations 224 and 222, respectively, in Final Table 220.

When a particular normalized data record is to be added, API routine 106 instructs processor 122 to query normalized database 108 to set the associated Changed Flag to “Yes”, and initiate data masher routine 112-1, taking the newly-added normalized data record into consideration. Processor 122 then performs steps 602-608 with the newly-added normalized data record included. This process yields a third final record that has data selected from one or more equivalent normalized data records, including the newly-added normalized data record. This third final record may or may not be the same as the previous final record. Data masher routine 112-1 then instructs processor 122 to set the associated Changed Flag to “No,” and a new primary key index value is assigned to the record. The new primary key index and the third final record are stored in locations 224 and 222, respectively, in Final Table 220.

In accordance with other embodiments of the invention, instead of simply mashing the normalized listings, historical normalized directory listings are analyzed to extract and deduce information. It should be noted that while we use the term “historical listings” because this aspect of the invention can extract and deduce information from old as well as from active listings (and because the more available data there is to analyze the more that can be accomplished with the invention), we do not mean to use the term in a limiting sense. This aspect of the invention can be used powerfully with current listings, and the term “historical listings” is meant to broadly cover current listings, old listings and a combination of the two.

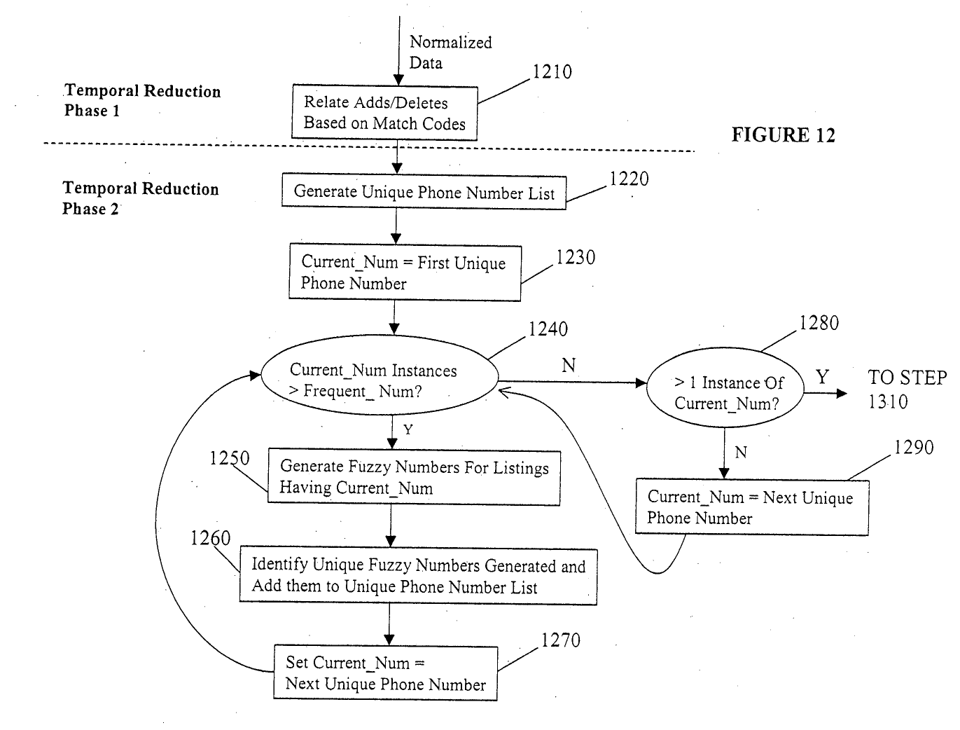

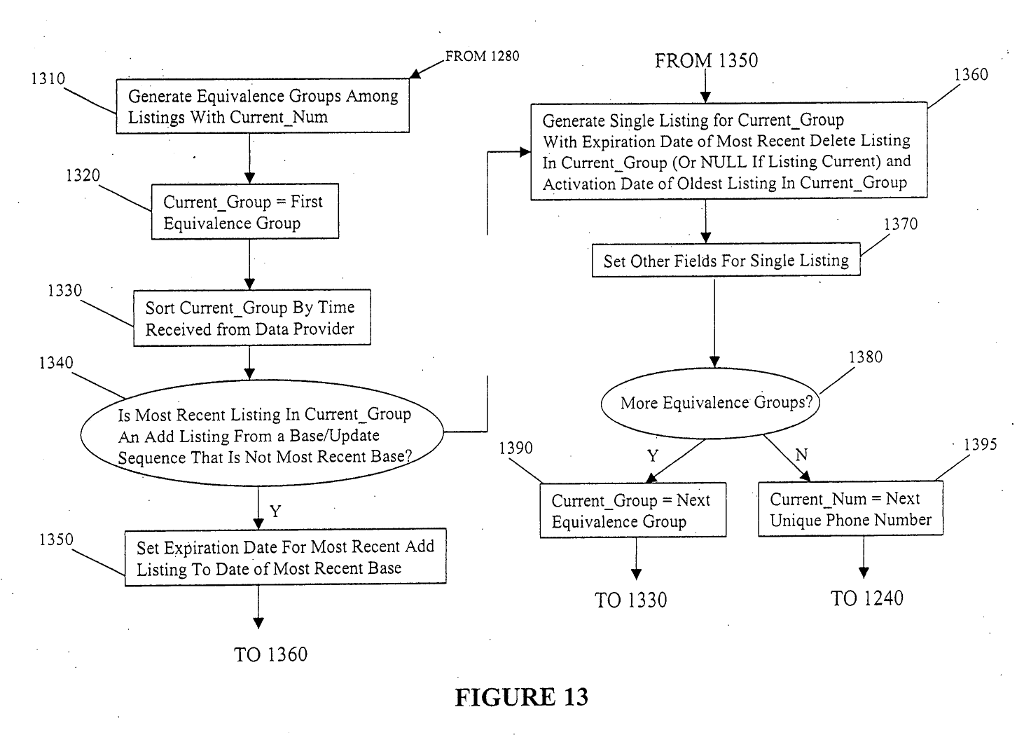

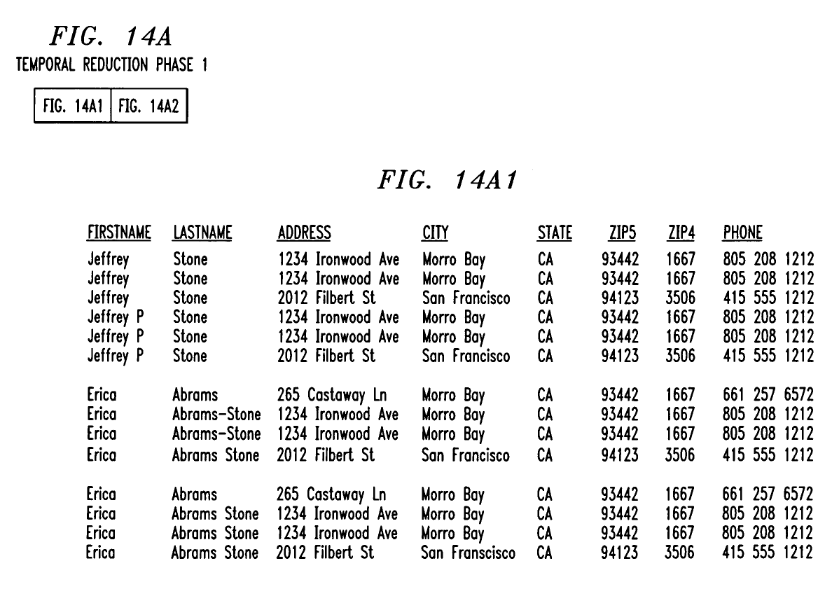

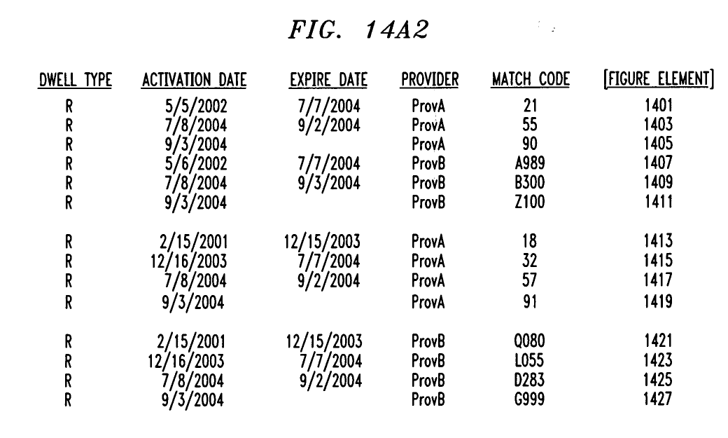

In one embodiment, after the data has been normalized and stored in normalized database 108, “temporal reduction” is performed on the normalized data. The goal of temporal reduction is to relate all the “adds” and “deletes” for the same listing which are received from the same data provider in order to create a single record that describes when that listing became active and when (if at all) it expired. This facilitates, among other things, the support of times and time ranges in queries, analysis and results. A flow chart of one algorithm for performing temporal reduction is shown in FIGS. 12 and 13.

In a preferred embodiment, temporal reduction is performed by processor 122 in two phases. In phase one, performed at step 1210 of FIG. 12, listings with the same match code are combined into a single listing having the activation date of the “Add” listing and the expiration date of the “Delete” listing. The result of performing phase one of temporal reduction on the normalized data of FIGS. 11A and 11B are illustrated in FIG. 14, where it can be seen that listings 1101 and 1103 have been combined to form listing 1401, listings 1105 and 1107 have been combined to form listing 1403, listings 1127 and 1129 have been combined to form listing 1407, listings 1131 and 1133 have been combined to form listing 1409, listings 1111 and 1113 have been combined to form listing 1413, listings 1115 and 1119 have been combined to form listing 1415, listings 1121 and 1123 have been combined to form listing 1417, listings 1137 and 1139 have been combined to form listing 1421, listings 1141 and 1143 have been combined to form listing 1423, and listings 1145 and 1147 have been combined to form listing 1425. The listings generated by phase one of temporal reduction are stored, for example, in a temporal reduction phase one database (not shown) contained in memory 124.

In phase two of temporal reduction, listings from the same data provider which contain only non-substantive differences are combined. There are many reasons why multiple substantively equivalent listings might be sent by a data provider. As illustrated in FIG. 9, for example, Provider A sent Delete listing 902 (a Jeffrey Stone listing) on Jul. 7, 2004, and on the very next day sent Add listing 904 containing the same substantive information. The reason for the delete and add was to change the abbreviated form of the state name (“CA”) to the full state name (“CALIFORNIA”) to comply with Provider A's new listing rules. Similarly, Provider B sent Delete listing 926 (a Jeffrey P. Stone listing) on Jul. 7, 2004, and on the very next day sent Add listing 928 containing the same substantive information. The reason for this delete and add was to change the city name (“Morro Bay”) to the abbreviated form (“MRBY”). Note that while in these two examples the normalization process accounted for these differences in nomenclature, so the normalized data no longer reflects the reason for these multiple listings, that may not always be the case. The goal of temporal reduction phase two is to combine listings having the same substantive information into a single listing which identifies when that substantive information became active and when, if at all, it expired.

Turning back to FIG. 12, in one embodiment of the present invention, the first step of temporal reduction phase 2 is to generate a list of unique telephone numbers from all the listings received from the data provider. This is shown at step 1220. Because the steps which follow will be performed for each unique telephone number identified, a variable Current_Num is employed which is reset to the next unique telephone number after processing has been completed on the previous unique telephone number. At step 1230, Current_Num is set to the first of the unique telephone numbers identified in step 1220.

In step 1240, a count is made of the number of listings having Current_Num in the telephone field. If this number is inordinately large (e.g., it exceeds a “Frequent_Num” limit, which in a preferred embodiment is set to 300), the telephone number is likely the general number for a large business or governmental entity which lists the same general phone number in separate listings for each of its locations, divisions and/or departments. For example, we have observed that the Environmental Protection Agency has on the order of 50,000 different listings associated with the same telephone number, and that the listings for all of the different branches of the United States Postal Service throughout the United States contain the same toll-free telephone number. In such circumstances, temporal reduction is facilitated by matching like listings based on fuzzy representations of the telephone numbers rather than the telephone numbers themselves.

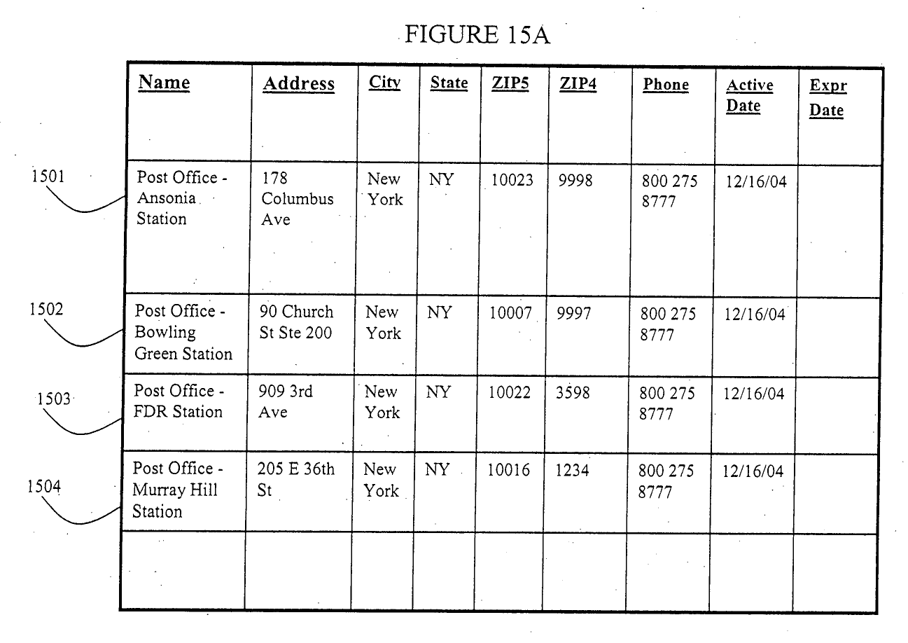

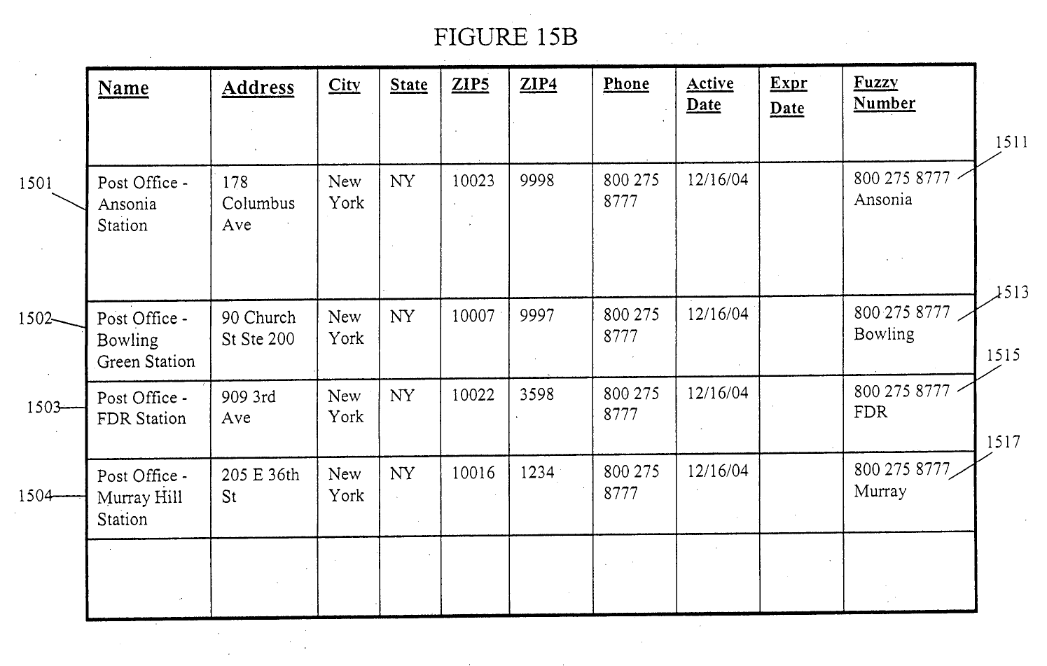

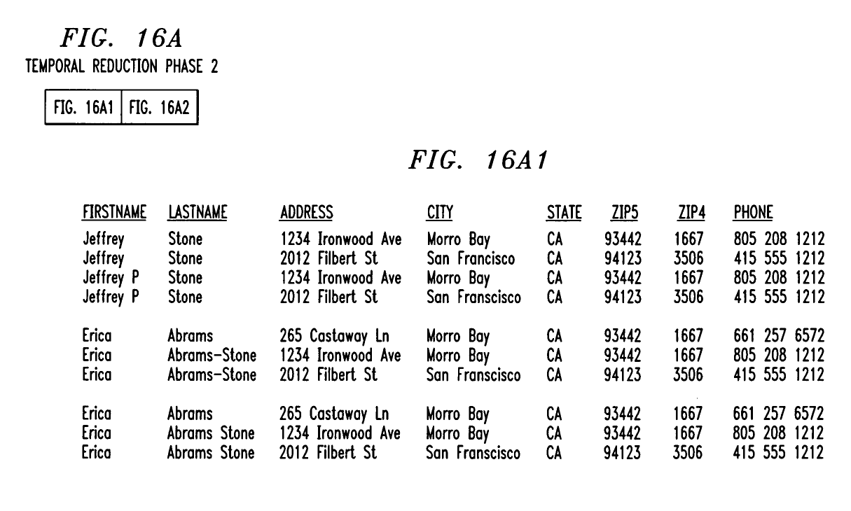

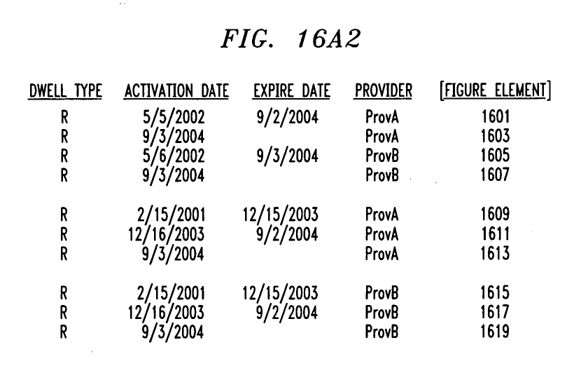

The fuzzy representations are generated at step 1250. In one embodiment, these fuzzy numbers are generated as a function of department, building and/or branch information associated with the listing. For example, suppose a subset of the normalized listings for post offices in New York, N.Y. are as shown in FIG. 15A, where four different listings (denoted 1501 through 1504) for four different post office locations are shown, each listing having the same telephone number. If the number of listings having this telephone number exceeds Frequent_Num, fuzzy representations of the telephone number are formed for each of the listings by appending the first name of the post office branch to the telephone number. The four listings of FIG. 15A after the fuzzy telephone numbers have been generated and associated with the listings are illustrated in FIG. 15B, where it can be seen that the fuzzy number “800 275 8777 Ansonia” (denoted 1511) has been generated for listing 1501, fuzzy number “800 275 8777 Bowling” (denoted 1513) has been generated for listing 1502, fuzzy number “800 275 8777 FDR” (denoted 1515) has been generated for listing 1503, and fuzzy number “800 275 8777 Murray” (denoted 1517) has been generated for listing 1504.

Those skilled in the art will appreciate that there are many ways fuzzy telephone numbers can be generated, all of which are within the scope of the invention. For example, the fuzzy telephone numbers may alternatively be generated as a function of the city, state and elements of a caption (e.g., department names) associated with the listing. In addition, while fuzzy telephone numbers are generated in a preferred embodiment, it is not necessary in order to practice the invention. For example, steps 1240-1270 can be omitted from the routine illustrated in FIGS. 12 and 13, and processing can proceed from step 1230 directly to step 1280.

After the fuzzy telephone numbers are generated and associated with their respective listings, at step 1260 the unique fuzzy telephone numbers are identified and added to the unique telephone number list generated at step 1220. Current_Num is then set to the next unique telephone number in step 1270, and processing returns to step 1240. Because unique fuzzy telephone numbers are processed starting in step 1240 like all other unique telephone numbers, an algorithm for generating fuzzy telephone numbers should be selected such that no fuzzy telephone number will have more than “Frequent_Num” number of instances.

If it is determined at step 1240 that the instances of Current_Num do not exceed Frequent_Num, processing proceeds to step 1280, where it is determined if there is more than one instance of Current_Num. If not, Current_Num is set to the next unique telephone number at step 1290 and processing is returned to step 1240.

If it is determined at step 1280 that there is more than one instance of Current_Num, then processing proceeds to step 1310 in FIG. 13, where an equivalence algorithm is run on all the listings having Current_Num as the telephone number. All listings which are deemed by the equivalence algorithm to be equivalent form an equivalence group. While, in a preferred embodiment, the conversion and normalization rules are sufficiently comprehensive that making equivalence determinations on normalized listings is a relatively straightforward process, all methods for determining equivalence are embraced by the instant invention. Of course, the equivalence algorithm should account for the fact that “equivalent” listings can have different activation and expiration dates since, as described above, one goal of temporal reduction is to combine listings where Add and Delete listings (like listings 902 and 904) were sent for reasons unrelated to the substance of the listings.

Once the equivalence groups have been identified, processing proceeds to step 1320. Because the steps which follow will be performed for each equivalence group, a variable Current_Group is employed which is reset to the next equivalence group after processing has been completed on the previous equivalence group. At step 1320, Current_Group is set to the first of the equivalence groups identified in step 1310.

In step 1330, the Current_Group of listings is sorted by the time they were received from the data provider. In one embodiment, the listings in the Current_Group may not have time gaps therebetween by, say, more than three days, or overlap in time by, say, more than three days. In step 1340, it is determined whether the most recent listing in the group is an Add listing from a base listing/update listing sequence that is not the most recent base/update sequence. (All active directory listings are sent by data providers at defined intervals as comprehensive “base” listings. In between base listings, updates listings are sent to keep directory listing databases current). If it is, the expiration date of that listing is set date of the most recent base listing in step 1350, after which processing proceeds to step 1360. Otherwise, processing proceeds from step 1340 directly to step 1360.

In steps 1360 and 1370, a single listing is generated which represents all of the listings in Current_Group. In step 1360, the activation date of this listing is set to the activation date of the oldest listing in Current_Group, and the expiration date is set to either the expiration date of the last received Delete listing in the equivalence group, or the null value if the listing is current. In step 1370, the other fields of this listing may be set according to the information service provider's preferred algorithm. This may be done, for example, by using the fields in the most recent listing, or by any other method. When step 1370 is complete, then, all of the listings in Current_Group have been combined into a single listing which identifies when the substantive information common to those listings became active and when, if at all, it expired.

After the single listing for the equivalence group has been generated, it is determined in step 1380 whether there are any more equivalence groups having Current_Num which have not yet been reduced to a single listing. If so, in step 1390, Current_Group is set to the next equivalence group and processing proceeds to step 1330. Otherwise, in step 1395, Current_Num is set to the next unique telephone number and processing proceeds with step 1240.

FIG. 16 illustrates the listings generated by performing phase two of temporal reduction on the listings of FIG. 14 pursuant to an illustrative embodiment. As illustrated in these figures, listings 1401 and 1403 have been combined to form listing 1601, listings 1407 and 1409 have been combined to form listing 1605, listings 1415 and 1417 have been combined to form listing 1611, and listings 1423 and 1425 have been combined to form listing 1617. While we have described one preferred way to perform temporal reduction, those skilled in the art will appreciate that there are any number of ways to achieve temporal reduction or its equivalent, all of which are within the scope of the instant invention. The temporally reduced listings are stored, for example, in a temporally reduced listings database (not shown) contained in memory 124.

Once the listings from all of the data providers are temporally reduced, each of the resulting temporally reduced listings in a preferred embodiment is used as a vertex in a graph. Therefore, each is assigned a unique vertex label which can be used for vertex referencing, for storing additional information about the listing (vertex) and/or for use in defining and storing the edges between the vertices. While there are, of course, many ways in which such unique vertex labels can be generated, in a preferred embodiment, the labels are generated such that they contain additional substantive information about the listing. For example, NPA split information can be incorporated into the vertex label if the area code of the listed telephone number is the result of an NPA split. In such an embodiment, a vertex label might take the form <NPA>_<NPA Split Group>_<Unique Identifier>.

In order to achieve the benefits of parallel processing when generating vertex labels, in a preferred embodiment, a multi-step process is employed by system 102 to generate the unique identifier component. Each process or agent responsible for assigning vertex labels to a subset of the listings requests a prefix identifier from a global ID broker (not shown), an identifier which is unique for all time across all agents and processes. The individual agent or process then generates a different integer to append to each of the listings it is processing (which can be done, for example, by simply incrementing the last integer used). In such an embodiment, the form of the vertex label might be <NPA>_<NPA Split Group>_<Globally Unique Identifier>_<Sequentially Incremented Integer>.

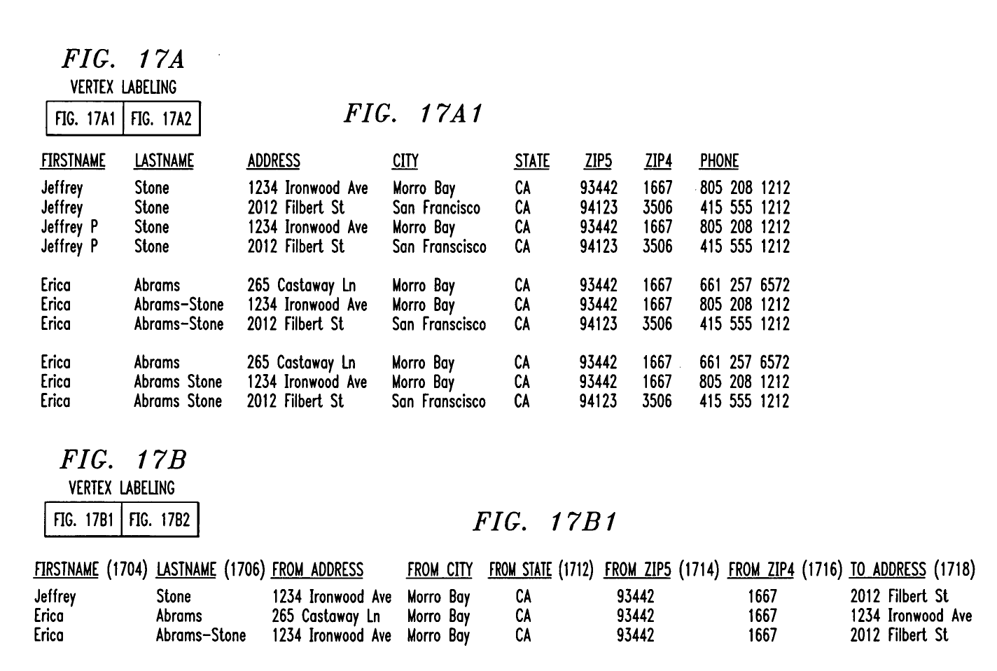

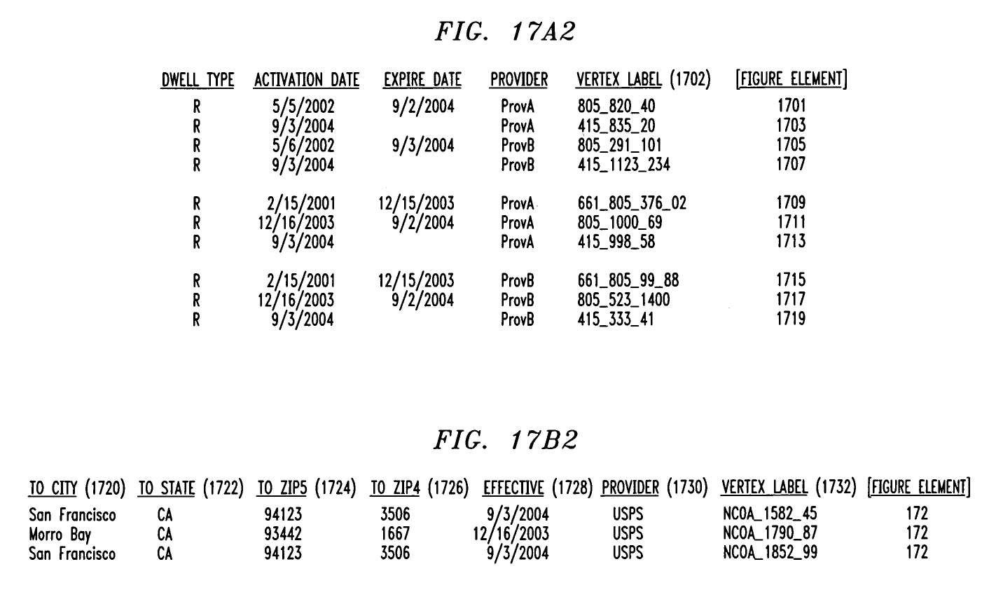

FIG. 17A illustrates the listings of FIG. 16 (listings 1701-1719 correspond to listings 1601-1619, respectively) with the addition of vertex labels thereto (the vertex label field is denominated 1702 in FIG. 17A). All of these listings have been assigned three-field vertex labels except those for telephone numbers having area codes of 661 (listings 1709 and 1715), which have four fields. In 1999, the 805 area code was split into 805 and 661. Therefore, pursuant to one of the preferred methods for labeling vertices (which is described above), the 661 area code listings have the additional NPA split field in the vertex label, which is set to 805. We note that, when using a vertex labeling scheme that incorporates NPA split information, it is possible to incorporate only NPA splits that occurred after a certain date, and not all splits which occurred over all of time. The vertex labels in a preferred embodiment are stored with the temporally reduced listings in a master graph vertex database (not shown) contained in memory 124.

While the present invention is certainly very powerful when it employs only directory listing vertices, in a preferred embodiment, the graph can be formed using vertices generated from other information as well. Strictly by way of example, vertices can be employed which are generated from:

1) Do Not Call Telephone Numbers: Vertices can be created which contain the telephone numbers on the national Do Not Call registry. This can be done by employing one vertex containing all of the numbers on the registry, by employing one vertex for every telephone number, or by using multiple vertices each containing a plurality of the numbers on the registry.

2) National Change of Address (NCOA) Information: The Postal Service's NCOA data can be used to generate vertices containing move information. In a preferred embodiment, a different NCOA vertex is created for every change of address, and contains information such as the name of the person or entity which moved, the old address (including city, state, and nine digit zip code), the new address (including city, state, and nine digit zip code) and the effective date of the move.

3) Telephone Company Information: Telephone company information (e.g., LERG routing guides) can be used to generate vertices containing associations between telephone numbers and service providers (e.g., which service providers provide service for which telephone numbers), associations between service type and telephone numbers (e.g., is the number a wireless number, wireline number, pager number etc.), etc. In a preferred embodiment, every discrete association forms a different vertex. For example, there would be one vertex indicating that the telephone number 212-684-0648 is a Verizon telephone number, and a different vertex indicating that it is a landline number.

4) Equifax Header Information: This data includes information such as name, date of birth, address, social security number and employment history. The Equifax credit information itself may also be incorporated into vertices. All of the Equifax information about one individual can be stored in the same vertex, or different vertices can be used for discrete information (e.g., one vertex indicating that Jane Doe's social security number is 123-45-6789 and another vertex containing her employment history). Obviously, information from other credit reporting services can also be used to form vertices.

5) Demographic Information: There are a number of services which provide demographic information about individuals and/or households, information which can be used as vertices. This includes information relating to purchasing history (e.g., magazines subscribed to, cars purchased etc.), ownership information (e.g., number and types of cars and registration information, audio/visual equipment, number and types of houses and other dwellings, horses, boats etc.), vacations taken, businesses owned, investments, charitable contributions, restaurants frequented, hobbies, books read, credit cards used and usage patterns, credit limits, age, gender, marital status, income, own/rent, children names and ages, education etc. All demographic information about one person, household or other entity can be contained in a single vertex, multiple vertices can be used to contain different types of demographic information about the same person or entity, or vertices containing demographic information can be formed in any other way.

The labels for non-directory listing vertices can be generated in any way such that they are unique. In a preferred embodiment, each such vertex label includes an indication of the type of vertex it is associated with (e.g., Do Not Call, NCOA etc.). One possible form for such vertex labels is <Vertex Type>_<Globally Unique Identifier>_<Sequentially Incremented Integer>, where “Globally Unique Identifiers” and “Sequentially Incremented Integers” are generated as described above.

Referring to FIG. 17B, it can be seen that three NCOA vertices are employed in this example. Labeled “NCOA_{—}1582_{—}45” (vertex 1721), “NCOA_{—}1790_{—}87” (vertex 1723) and “NCOA_{—}1852_{—}99” (vertex 1725), they represent Jeffrey Stone's move from 1234 Ironwood Ave to 2012 Filbert St, Erica Abrams' move from 265 Castaway Ln to 1234 Ironwood Ave, and Erica Abrams-Stone's move from 1234 Ironwood Ave to 2012 Filbert St, respectively. In a preferred embodiment, non-directory listing vertices are also stored in the master graph vertex database.

As will be appreciated by those having ordinary skill in the art, more, less or different non-directory listing vertices can be employed utilizing the principles of the instant invention. In addition, while preferred embodiments are provided with respect to how these vertices are formed and labeled, it will be appreciated that these are merely non-limiting embodiments. How vertices should be formed, what information should be contained in vertices and how vertices should be labeled are implementation decisions based on, among other things, the information desired to be extracted and/or deduced, the available raw data, available processing power, the real time query capabilities which will be supported and the graph edges and subgraphs desired (described below).

Once the vertices of the graph are generated and labeled, the edges between them are generated. Each edge in a preferred embodiment represents, and contains information regarding, a relationship between the two vertices it connects. Each edge in a preferred embodiment is unidirectional; when there is a bidirectional relationship between two vertices, two unidirectional edges are generated. Pertinent attributes, knowledge, information (analyzed or inferred) etc. about the relationship between two vertices are represented and stored as edges. In a preferred embodiment, each edge is stored as a three column table, where the first two columns of the stored edge contain the source and destination vertex identifiers and the third column contains the edge type (e.g., the relationship between the vertices that the edge represents). This table is stored in a master graph edge database (not shown) contained in memory 124. Those skilled in the art will appreciate, however, that edges can contain other types of information and can be stored in any way, and that all edge generation methods, edge types and edge storage techniques are within the scope of the instant invention.

The types of edges between directory listing vertices which may be supported, and the relationships they represent, include, but not limited to:
Last Name: A Last Name (“LN”) edge connects two vertices having last name fields which are substantively identical. In a preferred embodiment, non-substantive differences between the ways different data providers populate the last name fields of their listings are accounted for. For example, some data providers may use a hyphen between last names having two words (e.g., “Abrams-Stone”), and some may not.
First Name: A First Name (“FN”) edge connects two vertices having first name fields which are substantively identical. In a preferred embodiment, non-substantive differences between the ways different data providers populate the first name fields of their listings are accounted for. For example, some data providers may include a middle initial in the first name field, and some may not.
City: A City edge connects two vertices having the same substantive information in their “city” fields. While the normalization procedure may have accounted for any nomenclature differences between data providers, in a preferred embodiment, any remaining non-substantive differences between city representations are accounted for when determining whether or not to create a City edge.
State: A State edge connects two vertices having the same substantive information in their “state” fields. While the normalization procedure may have accounted for any nomenclature differences between data providers, in a preferred embodiment, any remaining non-substantive differences between state representations are accounted for when determining whether or not to create a State edge.
Address: An Address edge connects two vertices having the same substantive information in their “address” fields. While the normalization procedure may have accounted for any nomenclature differences between data providers, in a preferred embodiment, any remaining non-substantive differences between address representations are accounted for when determining whether or not to create an Address edge.
ZIP-5: A Zip-5 edge connects two vertices having the same substantive information in their “zip-5” fields. Although there would generally not be nomenclature differences between “zip-5” fields, and any nomenclature differences that did exist would generally be accounted for by the normalization procedure, in a preferred embodiment, any remaining non-substantive differences between zip-5 representations are accounted for when determining whether or not to create a Zip-5 edge.
ZIP-4: A Zip-4 edge connects two vertices having the same substantive information in their “zip-4” fields. Although there would generally not be nomenclature differences between “zip-4” fields, and any nomenclature differences that did exist would generally be accounted for by the normalization procedure, in a preferred embodiment, any remaining non-substantive differences between zip-4 representations are accounted for when determining whether or not to create a Zip-4 edge.
Telephone Number: A Telephone Number edge connects two vertices having the same substantive in formation in their telephone number fields. While the normalization procedure may have accounted for any nomenclature differences between data providers, in a preferred embodiment, any remaining non-substantive differences between telephone number representations are accounted for when determining whether or not to create a Telephone Number edge.
Time Sequence (TS): A TS edge connects two vertices when the activation date of one vertex closely follows the expiration date of the other vertex, where the criteria for “closely follows” can be an implementation variable.
Time Overlap (TO): A TO edge connects two vertices when the periods during which the two vertices were active overlap at least in part.
Time Equivalence (TE): A TE edge connects two vertices when the periods during which the two vertices were active are identical, or almost identical, where the criteria for “almost identical” can be an implementation variable.
Equivalent: If the analysis of the fields of the two vertices would result in the generation of Last Name, First Name, Address, City, State, Zip 5, Zip 4 (if the zip 4 fields are populated), Telephone Number and TE edges between them, the two vertices are deemed to be equivalent. If that is the case, two unidirectional Equivalent edges are generated between the two vertices instead of generating all of the other edges.

Because the existence of the relationships represented by edges cannot always be determined with 100% certainty, in one embodiment, edges can contain confidence levels generated by a modifiable set of rules. For example, it may be determined that it is 95% likely that a name field which contains two words separated by a space (e.g., “Abrams Stone”) is the same as a name field which contains the same two words separated by a hyphen (e.g., “Abrams-Stone”). However, it may be determined that it is only 60% likely that a name field which contains two words is the same as a name field which contains only one of the two words. The rules for collecting subgraphs (explained below) can then be based on confidence levels among the other subgraph collection criteria.

The edge types between directory listing vertices and other vertex types will likely be somewhat different than those identified above. For example, there might be “Do Not Call” (“DNC”) edges between directory listing vertices and Do Not Call vertices. In a preferred embodiment, two unidirectional DNC edges are generated between a directory listing vertex and a Do Not Call vertex. In this way, graph traversal algorithms can be employed either to determine the Do Not Call history of specific individuals (e.g., traversing the graph from a directory listing vertex to a Do Not Call vertex) or to determine details about those individuals whose telephone numbers are on the Do Not Call list (e.g., originating graph traversal from a Do Not Call vertex).

Edge types between directory listing vertices and NCOA vertices may include “Move From” and “Move To” edges which can be used, for example, to determine where people lived and when, as well as to assimilate this information with other information discernable from the graph (an example of which is provided below). In a preferred embodiment, rules are employed such that Move To and Move From edges can be generated even if the last name fields of the directory listing vertex and the NCOA vertex are not identical. This is desirable because, for example, women sometimes change their names when they get married, meaning an NCOA vertex may contain a women's maiden name while her current directory listing may contain her married name. One way to address this issue is by creating a Move From edge when (i) the first name of the directory listing vertex corresponds to the first name of the NCOA vertex (denominated 1704 in FIG. 17B); and (ii) the street address, city, state, and zip code fields of the directory listing vertex are the same as the “from” address, city, state and zip code fields (denominated 1708, 1710, 1712, 1714 and 1716 in FIG. 17B) of the NCOA vertex; and (iii) the expiration date of the directory listing vertex closely corresponds with the effective date of the NCOA vertex (denominated 1728 in FIG. 17B). Similarly, a Move To edge can be created when (i) the first name of the directory listing vertex corresponds to the first name of the NCOA vertex; (ii) the street address, city, state, and zip code fields of the directory listing vertex are the same as the “to” address, city, state and zip code fields (denominated 1718, 1720, 1722, 1724 and 1726 in FIG. 17B) of the NCOA vertex; and (iii) the activation date of the directory listing vertex closely corresponds with the effective date of the NCOA vertex. In a preferred embodiment, only one unidirectional Move From edge is generated from a directory listing vertex to a NCOA vertex, and only one unidirectional Move To edge is generated from a directory listing vertex to a NCOA vertex. It will be appreciated, however, that two unidirectional and opposite “Move From” and “Move To” edges can be generated between NCOA and directory listing vertices if graph traversal in both directions is desired. Edges between directory listing vertices and other vertex types can also contain confidence levels.

Obviously, it is not possible to provide a complete set of possible edge types, since the types and uses of edges are virtually limitless. While examples of edge types and rules for generating them are provided, the invention is not limited to these examples. The decision as to which edge types to employ and the rules for generating them can be made as a function of the types of vertices in the graph, the information desired to be extracted and/or deduced, available processing power, the real time query capabilities which will be supported and the desired subgraphs. With the benefit of the instant disclosure and the examples of edge types provided herein, those skilled in the art will appreciate how to select appropriate edge types for their own implementations of the instant invention and how to define suitable rules for generating those edge types.

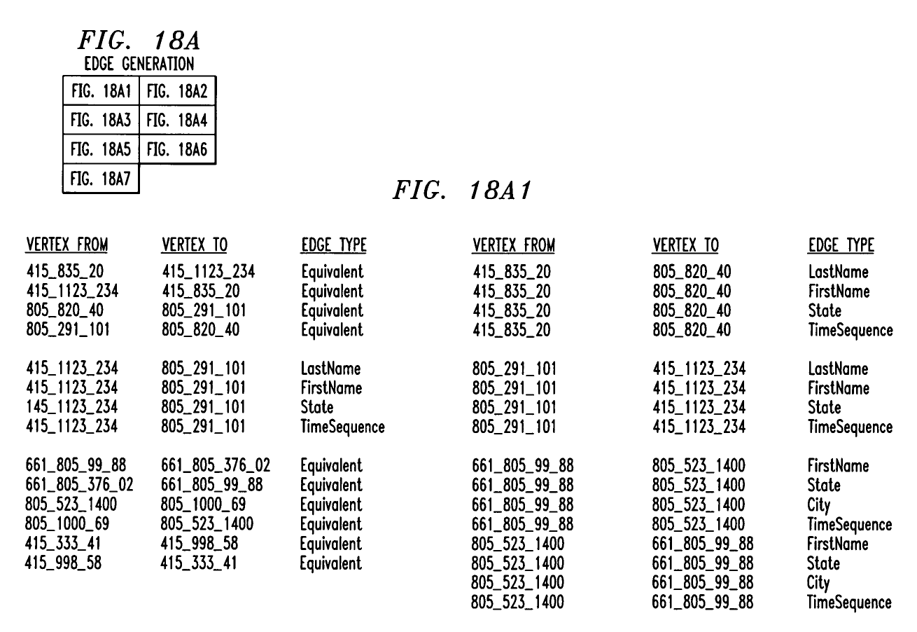

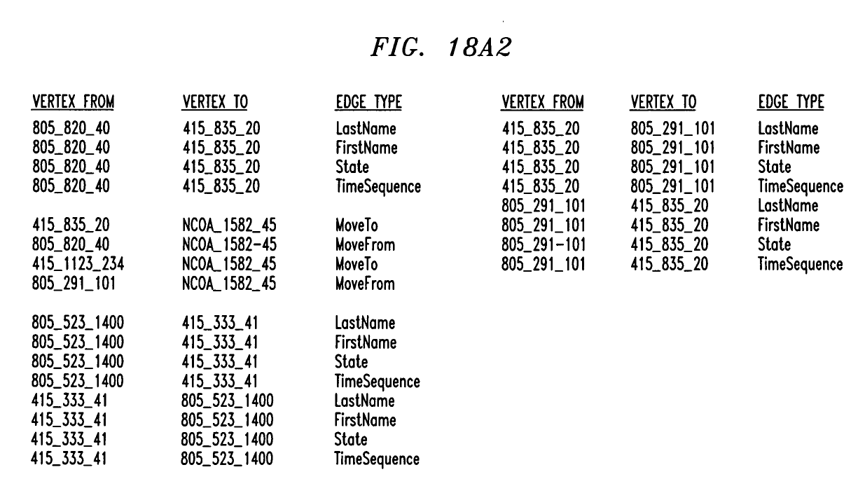

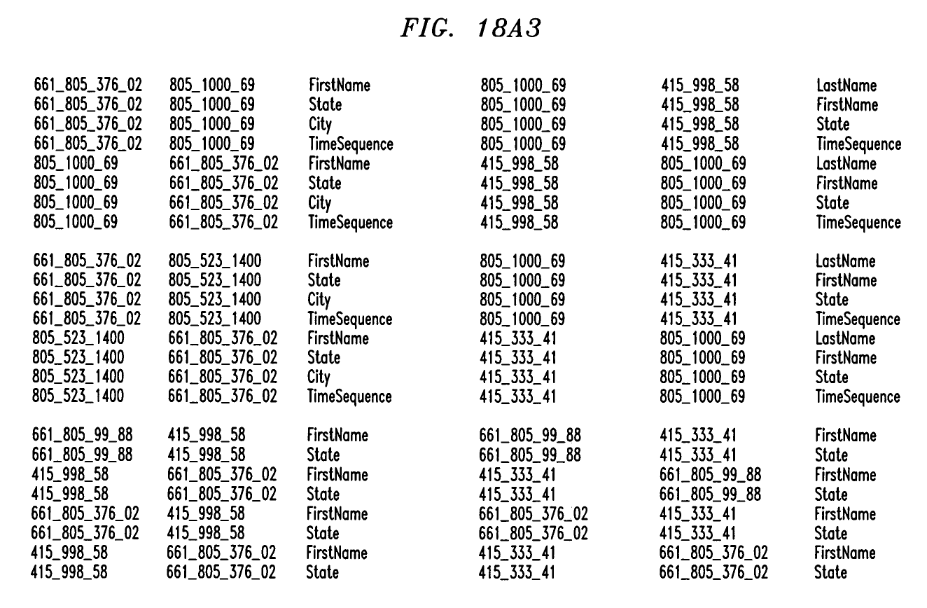

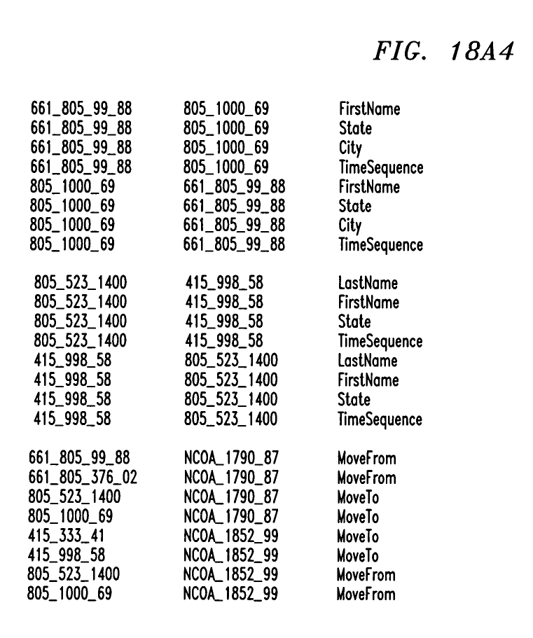

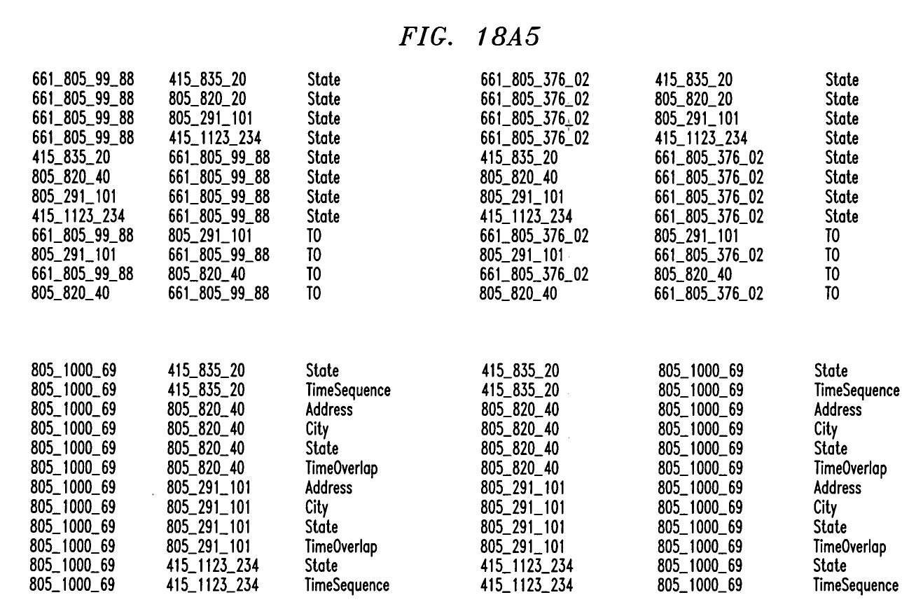

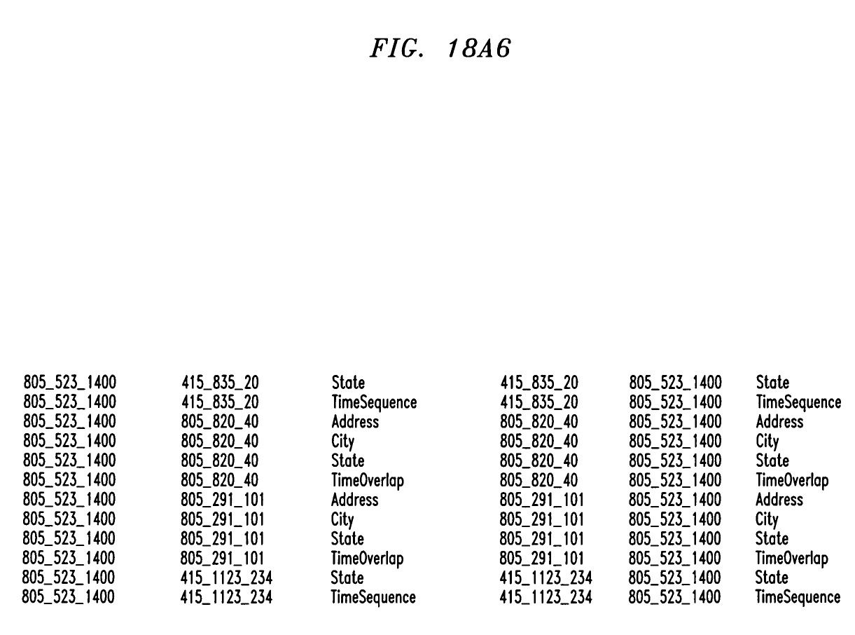

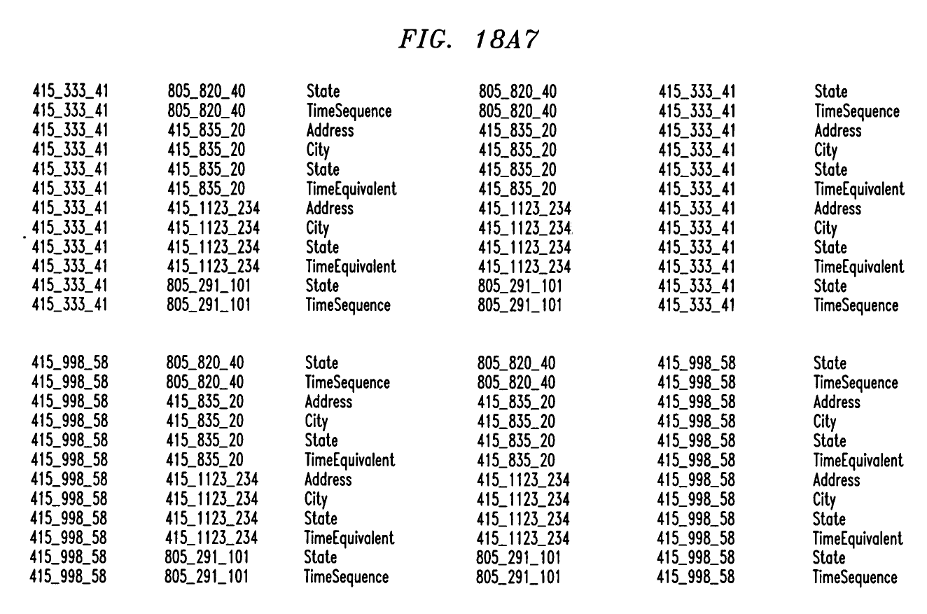

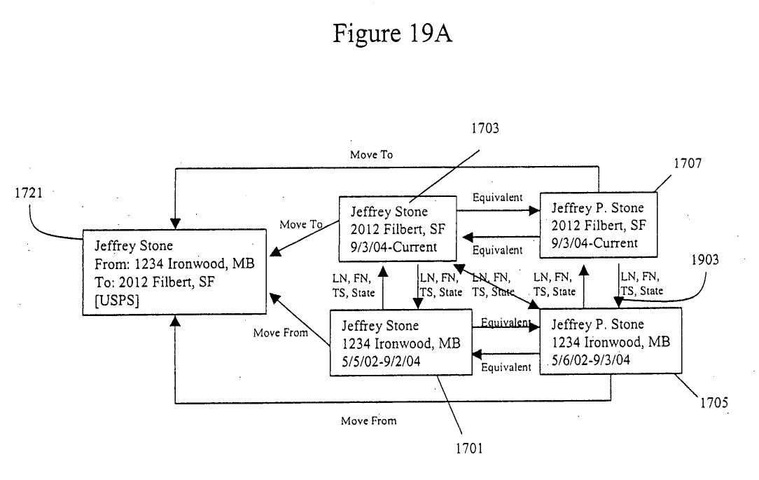

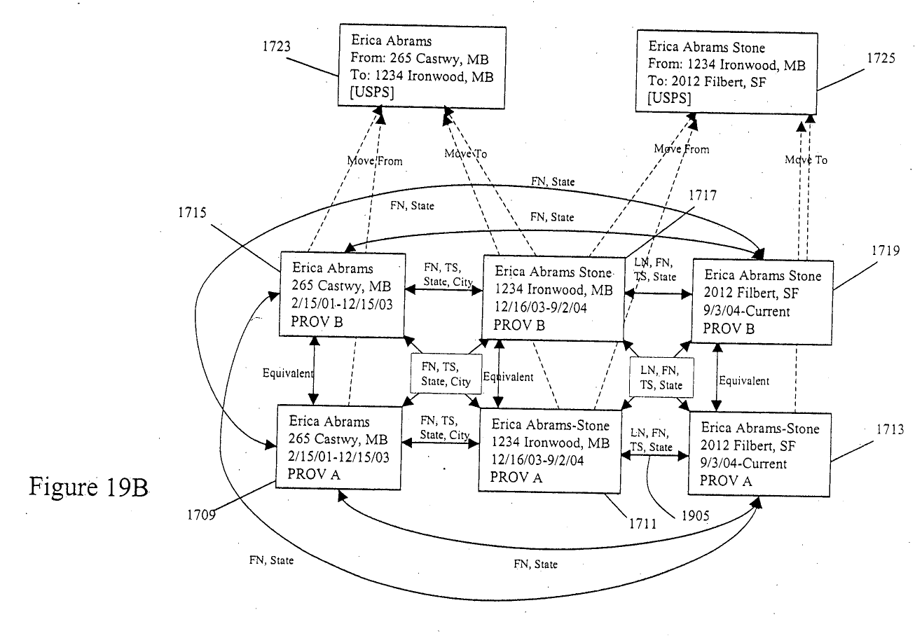

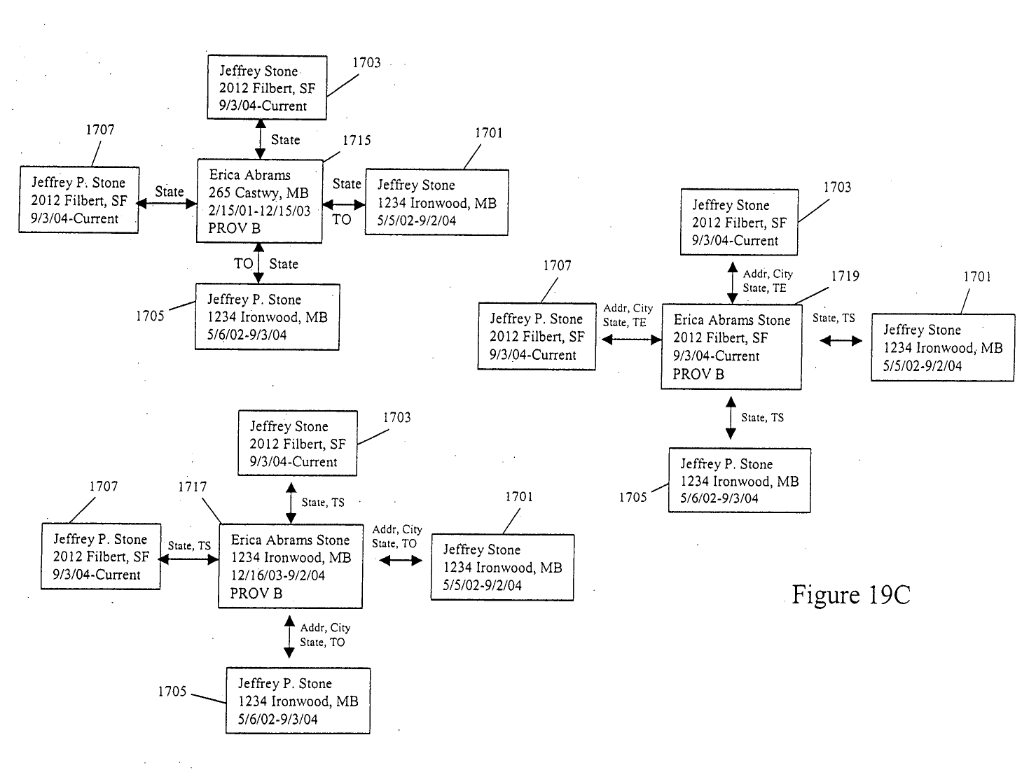

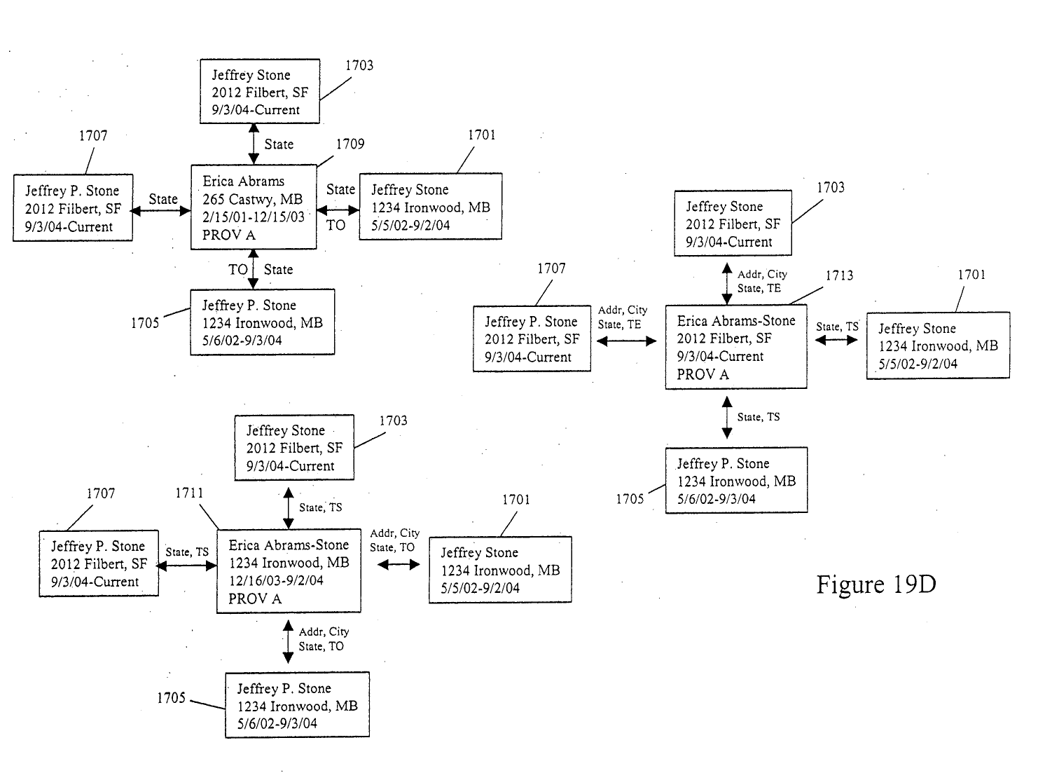

FIG. 18 illustrates edges created between the vertices of FIGS. 17A and 17B. The vertices of FIGS. 17A and 17B and the edges between them (illustrated in FIG. 18), then, constitute one example of a master graph. To assist the reader in understanding the graph, as well as how it is processed (described below), this master graph is drawn in FIGS. 19A-19D. However, we found that a true and accurate visual representation of this master graph would be so busy that the reader would not be able to discern anything from it. Therefore, for readability purposes only, we have chosen to draw this master graph such that: (i) FIG. 19A depicts the edges between vertices relating to Jeffery Stone (the edges generated between vertices 1701, 1703, 1705, 1707 and 1721); (ii) FIG. 19B depicts the edges between vertices relating to Erica Abrams (the edges generated between vertices 1709, 1711, 1713, 1715, 1717, 1719, 1723 and 1725); (iii) FIG. 19C depicts the edges between each of vertices 1715, 1717 and 1719 (vertices formed from directory listings relating to Erica Abrams sent by Data Provider B) and Jeffrey Stone-related vertices 1701, 1703, 1705 and 1707; and (iv) FIG. 19D depicts the edges between each of vertices 1709, 1711 and 1713 (vertices formed from directory listings relating to Erica Abrams sent by Data Provider A) and Jeffrey Stone-related vertices 1701, 1703, 1705 and 1707. For ease of visualization, vertices have been duplicated between these figures, (for example, vertices 1701, 1703, 1705 and 1707 each appear once in FIG. 19A, three times in FIG. 19C and three times in FIG. 19D), although the actual master graph has only one instance of every vertex. Further, by convention in FIGS. 19A-19D, a single unidirectional arrow between two vertices having a plurality of edge labels is used to depict a plurality unidirectional edges, one of each of the indicated types, and a single bidirectional arrow is used to represent two unidirectional arrows. For example, unidirectional arrow 1903 in FIG. 19A, which has four edge labels (“LN”, “FN”, “TS” and “State”), represents four unidirectional edges from vertex 1707 to vertex 1705, a “Last Name” edge, a “First Name” edge, a “Time Sequence” edge and a “State” edge. Similarly, bi-directional arrow 1905 in FIG. 19B, which has four edge labels (“LN”, “FN”, “TS” and “State”), represents eight unidirectional edges between vertex 1711 and vertex 1713, a “Last Name” edge, a “First Name” edge, a “Time Sequence” edge and a “State” edge from vertex 1711 to vertex 1713, and a “Last Name” edge, a “First Name” edge, a “Time Sequence” edge and a “State” edge from vertex 1713 to vertex 1711. Note that to avoid clutter, only a summary of the information contained in each vertex is depicted in FIG. 19. Each vertex is identified with its FIG. 17 label, however, so the reader can cross-reference to FIG. 17 to determine the actual content and form of the information stored in each vertex.

The embodiment of FIGS. 17-19 employs directory listing and NCOA type vertices, as well as the following edge types: Equivalent, Last Name, First Name, City, State, Address, TS, TE, TO, Move From and Move To (note that because neither zip code edges nor Telephone Number edges are employed in the embodiment of FIGS. 17-19, the zip codes and telephone numbers in the directory listing vertices are not illustrated in FIG. 19). Pursuant to the edge generation rules employed in this particular embodiment, “Abrams Stone” is deemed to be the same last name as “Abrams-Stone”, but “Abrams” is not deemed to be the same last name as “Abrams Stone” or “Abrams-Stone.” This is why, for example, there is no “LN” edge between vertex 1715 and vertex 1717 (or between vertex 1709 and vertex 1711) in FIG. 19B.

As described above, once edge generation is complete, a master graph of all the vertices and edges between them has been created. In a preferred embodiment, the size of the graph is then reduced by removing equivalent vertices in a process we call Distillation. Equivalent vertices can be identified as those vertices having an Equivalent edge between them. Which one of the equivalent vertices to keep in the graph, or the manner in which a representative vertex will be generated to represent equivalent vertices, will be determined by implementation specific rules (recall that equivalent vertices are not necessarily identical). These rules can be as simple as an instruction to favor one data provider's listings over others. Alternatively, a new representative vertex can be generated by picking and choosing fields from different data providers if different data providers are deemed to be more reliable with respect to different fields (a technique which is described in more detail above). All methods for identifying and eliminating equivalent vertices are within the scope of the instant invention. When an equivalent vertex is removed from the master graph, all edges to and from it are removed as well. In a preferred embodiment, the distilled graph is stored in a distilled graph database (not shown) contained in memory 124.

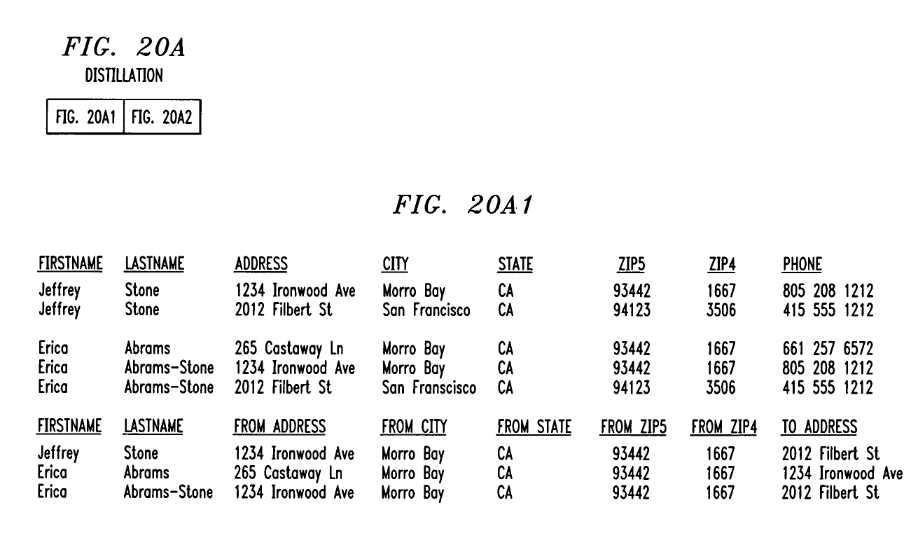

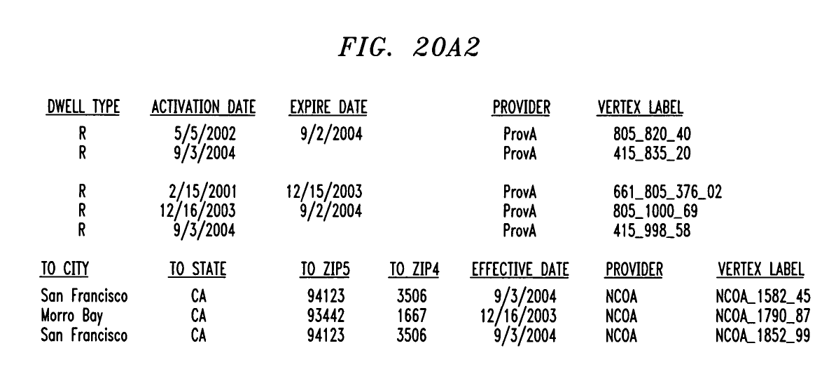

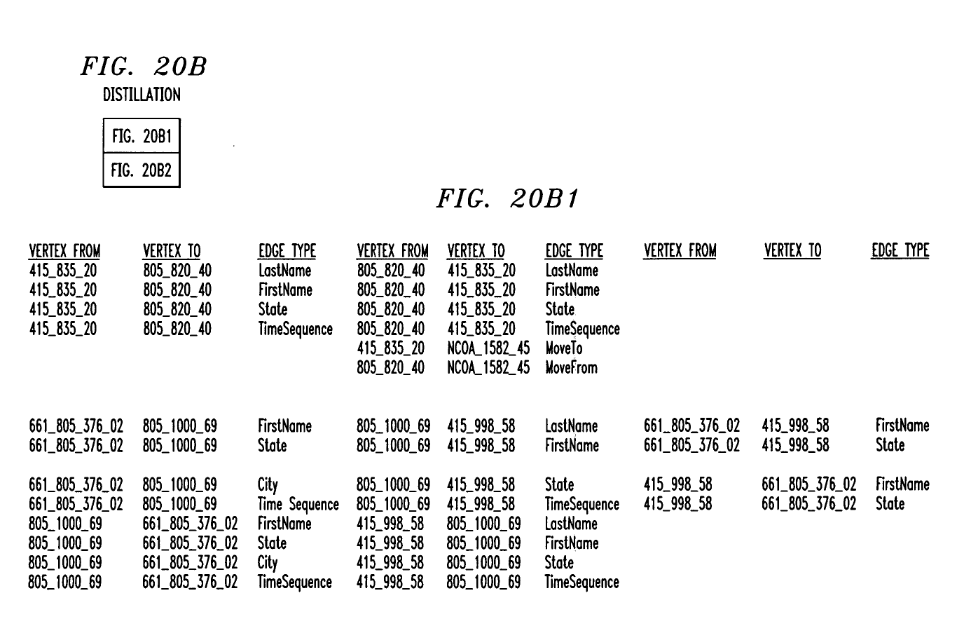

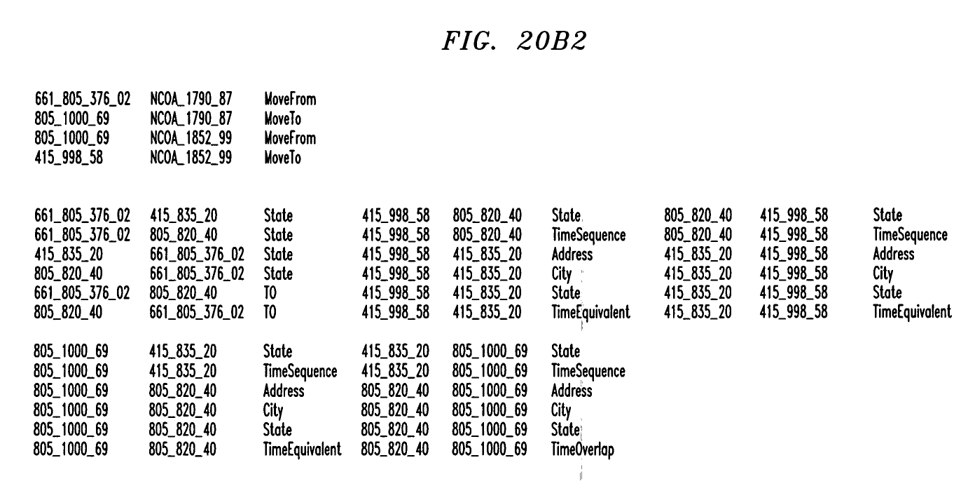

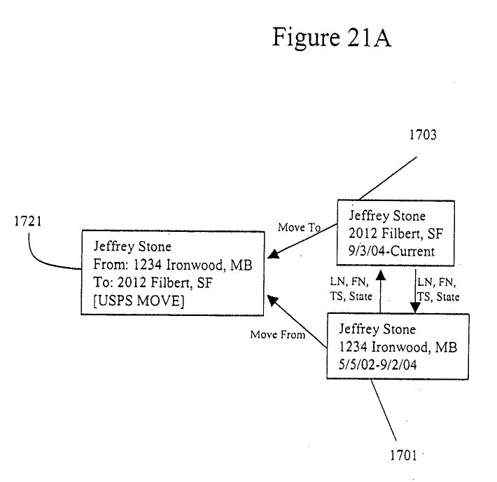

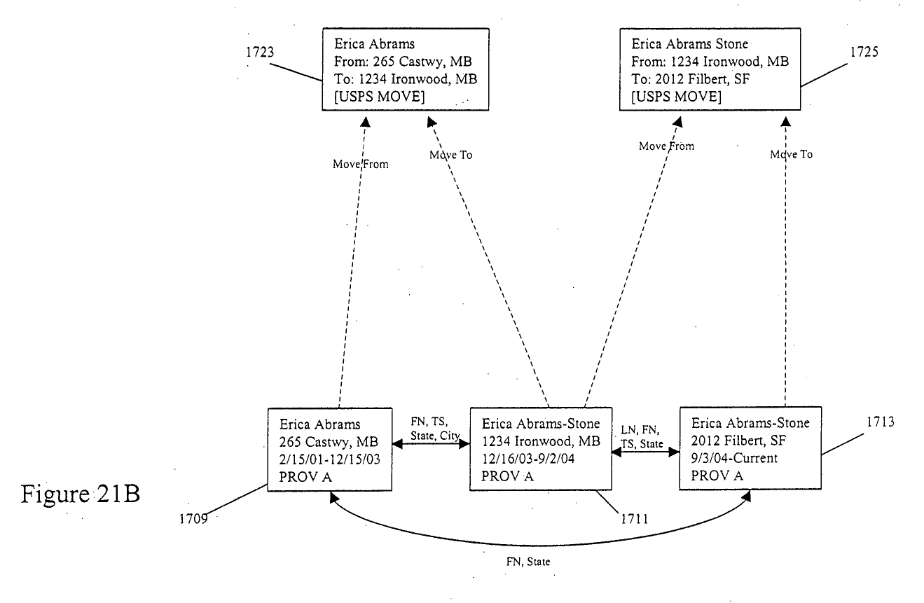

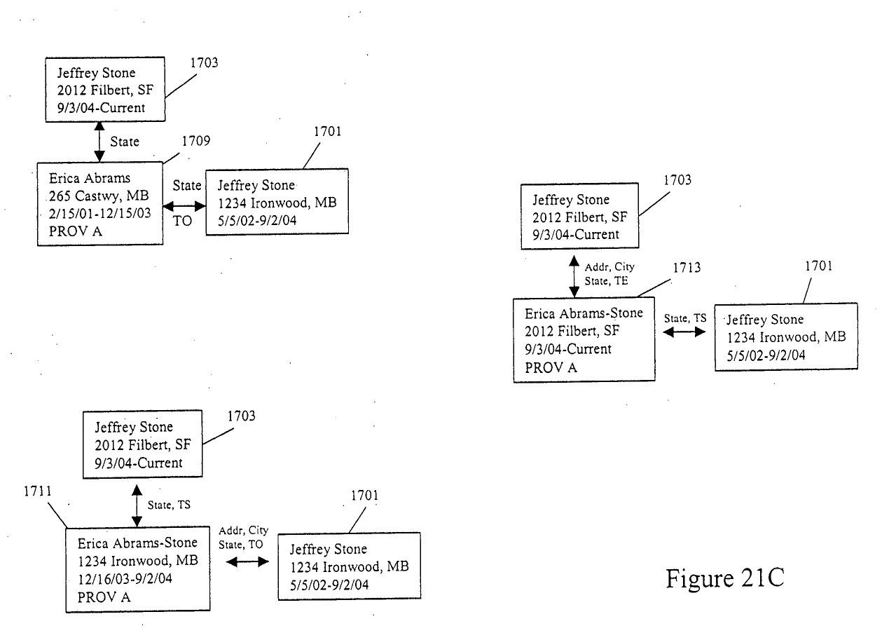

FIG. 20A and FIG. 20B illustrate the distilled version of the master graph of FIGS. 17-18, where FIG. 20A illustrates the vertices which remain after the vertices of FIG. 17 have been distilled, and FIG. 20B illustrates the edges which remain in the distilled graph. The distilled graph is drawn in FIGS. 21A-21C. As is evident from these figures, the distillation rules employed in this embodiment were to favor Provider A's listings over Provider B's listings. For example, FIG. 19B shows three vertices formed from listings received from Provider B, vertices 1715, 1717 and 1719, having Equivalent edges to/from three vertices formed from listings received from Provider A, vertices 1709, 1711 and 1713 respectively. As shown in FIG. 21B, after distillation, the vertices formed from listings sent by Provider B (1715, 1717 and 1719) no longer appear.

Those of ordinary skill in the art will appreciate that distillation can be done at any time after vertex generation, including after the subgraph generation process described next. In fact, it is not even necessary that the master graph be distilled at all. As described above, however, in a preferred embodiment, distillation takes place after edge generation, and it is the distilled graph that is used for information extraction and deduction.

In a preferred embodiment, information is extracted/deduced from the distilled graph by employing rules to traverse the distilled graph in order to create subgraphs thereof. The graph traversal rules used for generation of any given subgraph are defined such that the vertices in the subgraph which is generated satisfy certain criteria and/or have specified relationships with each other. The subgraph generation rules can be based on content of vertices, edges between vertices, a combination of the two or any other criteria. The decision as to which subgraphs to create, and which rules to use to create them, should be made as a function of the information to be extracted or deduced from the distilled graph and the available vertex and edge types. In a preferred embodiment, subgraphs are stored in a subgraph database (not shown) contained in memory 124.

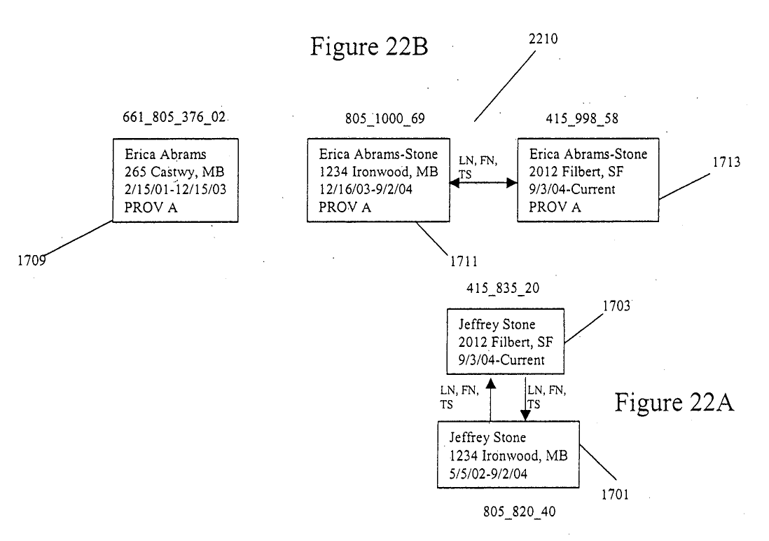

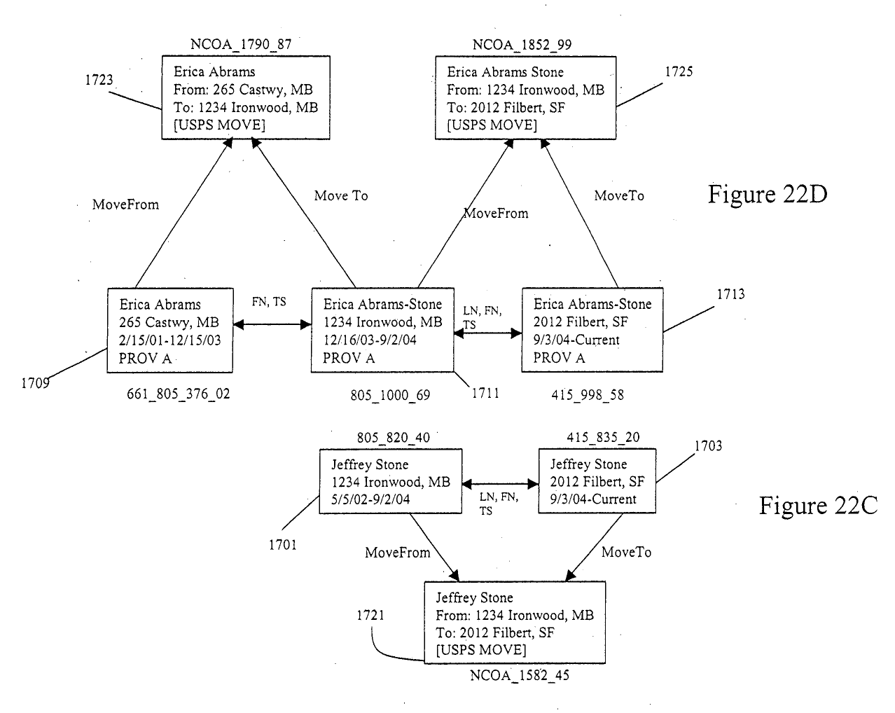

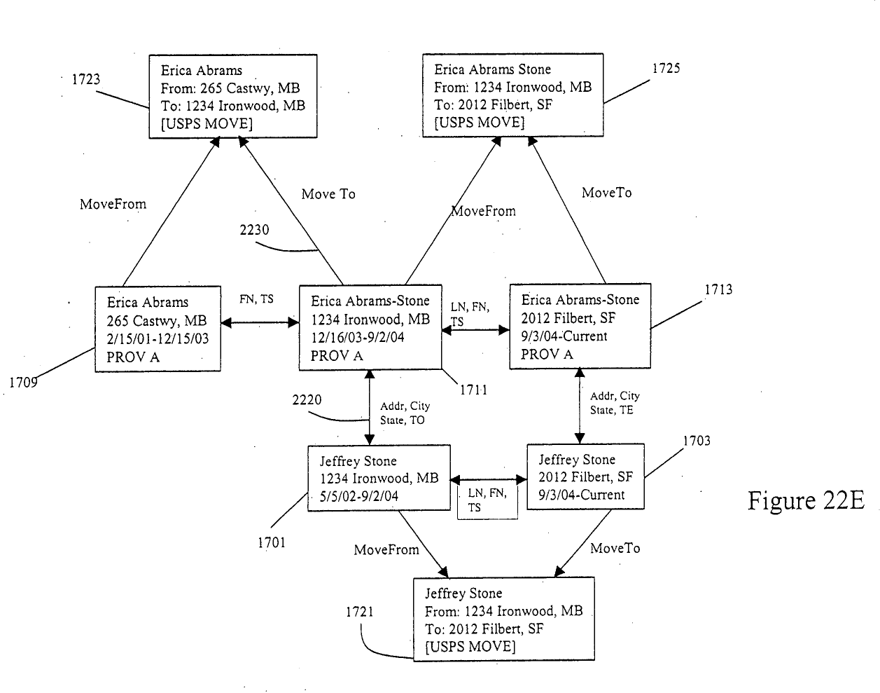

For example, as discussed above, we have determined that move history is an effective identification tool, either alone or in combination with other identification means. That is, individuals can be asked where they have lived in the past, and during what time periods, as a means of verifying their identities. In order to provide a move history verification service to customers, an information assistance service might use the distilled graph to create move history subgraphs which can later be searched to find the specific move histories of named individuals. One way to create such move history subgraphs might be to employ rules to traverse the distilled graph to identify vertices with Last Name, First Name and Time Sequence edges between them. FIGS. 22A and 22B are drawings of subgraphs that would be created by using these subgraph generation rules on the distilled graph of FIGS. 20 and 21. As shown in FIG. 22A, these subgraph generation rules worked to generate an accurate and complete representation of Jeffrey Stone's move history, at least insofar as it is possible to determine his move history from the data which has been sent by the data providers. (Note that in this example, “move history” includes telephone number change history, since the subgraph generation rules will capture telephone number listing changes even when the address does not change.)

However, as shown in FIG. 22B, these subgraph generation rules did not work as well with respect to Erica Abrams-Stone. Subgraph 2210 in FIG. 22B is the move subgraph created for her. Because Erica changed her name from “Erica Abrams” to “Erica Abrams-Stone,” vertex 1709 was not included in the move subgraph because no Last Name edge existed between it and either of the “Erica Abrams-Stone” vertices 1711 and 1713. Therefore, it may be useful to modify the move history subgraph generation rules to account for the fact that women sometimes change their names when they get married. These rules may make use of the available NCOA data and incorporate NCOA vertices into the subgraphs. For example, the rules can be modified to include vertices in move subgraphs to which there are only First Name and Time Sequence edges, but only if (i) such vertices have a Move To or Move From edge to an NCOA vertex, and (ii) there is a vertex at the other end of the First Name and Time Sequence edges that has a corresponding Move From or Move To edge to the same NCOA vertex. The subgraphs of the distilled graph of FIGS. 20 and 21 which are generated pursuant to these subgraph generation rules are illustrated in FIGS. 22C and 22D. As can be seen in FIG. 22D, vertex 1709 is now included in the move history of Erica Abrams-Stone.

In one further example, suppose it is desirable to offer a service to provide cohabitation information as well as move history information. An information assistance service might then use the distilled graph to create subgraphs containing both move history and cohabitation history, which can later be searched to find the specific move and cohabitation histories of named individuals. In order to generate such subgraphs, the move history subgraph generation rules used to generate the subgraphs of FIG. 22C can be further augmented to include vertices having Address, City, State and Time Overlap or Time Equivalence edges. The subgraph generated pursuant to these rules is drawn in FIG. 22E, from which it can be easily discerned both when Erica Abrams and Jeffrey Stone first started living together, and that Erica changed her name proximate to that time (likely indicating that they were married at about that time). For example, from vertices 1711 and 1723 and the Move To edge 2230 from 1711 and 1723, one can see that Erica moved to 1234 Ironwood on or about Dec. 16, 2003. From vertices 1711 and 1701 and the edges 2220 between them, one can see Jeffrey Stone already lived at 1234 Ironwood when Erica moved in, and that they both lived there until about Sep. 2, 2004.

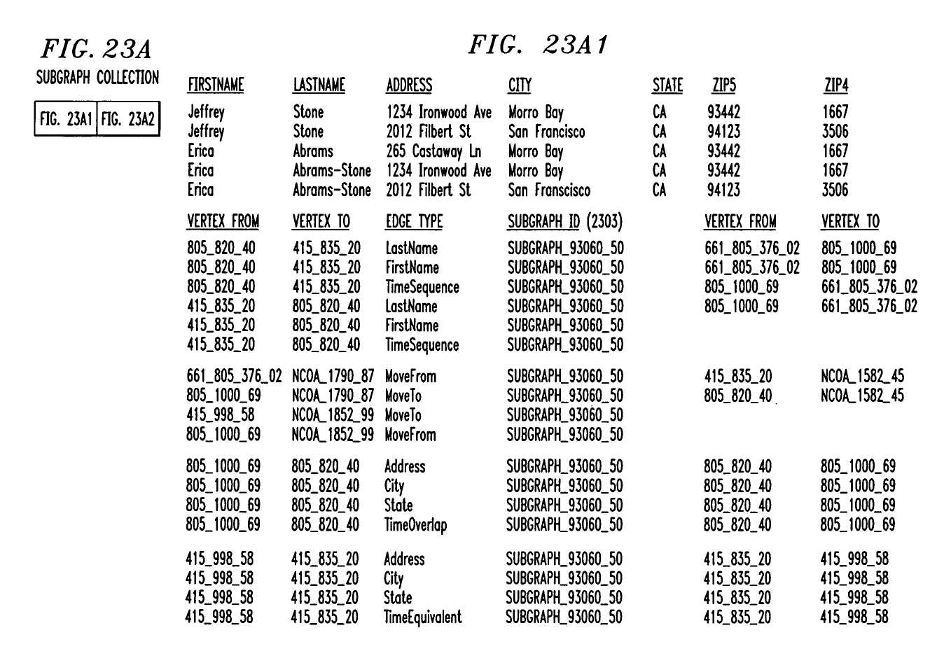

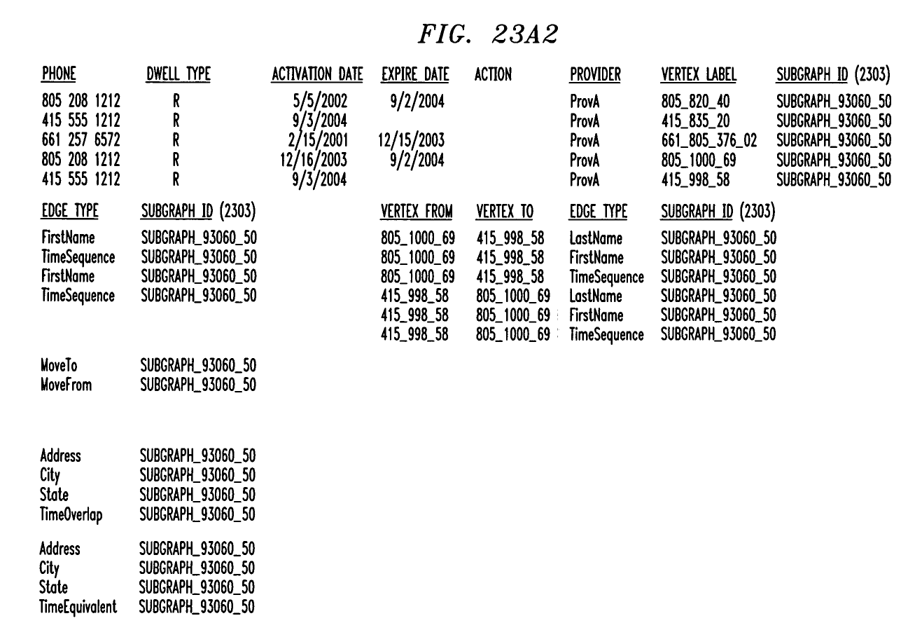

Data stored for this subgraph is illustrated in FIG. 23, where it can be seen that, in a preferred embodiment, all of the information in the vertices and edges which make up a subgraph are stored with the subgraph in the subgraph database. All edges and vertices included in a subgraph are tagged with a global subgraph identifier of the form SUBGRAPH_<GUID_Prefix>_<integer>, contained in field 2303, whereby all edges and vertices with the same subgraph identifier are part of the same subgraph. It is possible, however for vertices and edges to be included in more than one subgraph. When this occurs, in a preferred embodiment, the vertex and edge records are duplicated, one for each subgraph, with each such vertex and edge containing a different subgraph identifier. Those skilled in the art will appreciate that in alternative embodiments, only one copy of every vertex and edge can be maintained, each of which is associated with (e.g., is stored with, points to etc.) the subgraph IDs of all of the subgraphs it is in.

As discussed above, which subgraphs to generate should be decided as a function of the information to be extracted from the distilled graph and the available vertex and edge types. If gender data is available (e.g., contained in one or more vertices), a subgraph could be generated of only cohabitations between males and females (names could also be utilized to determine gender, but many names are gender neutral). If family information is available, a subgraph could be generated of men and women living together who have children. If the desire is to create a subgraph of men and women living together who have children, but family information is not available, a subgraph could be generated using whatever other indicia of the presence of children might be available; for example, a subgraph might be generated of men and women living together who have subscriptions to parent magazines. The possibilities are virtually limitless. These examples are simply intended to illustrate the analysis which should be undertaken at the implementation stage to generate the proper subgraph collection rules to achieve one's goals.

In a preferred embodiment, after the desired subgraphs have been generated by appropriate graph traversal algorithms, searchable subgraph database(s) are built. Formation of searchable database(s) should permit different fields of the vertices and edges which make up the subgraphs to be efficiently searched. Which field searches or field combination searches the searchable database(s) will support is an implementation decision that should be based on the subgraphs which have been generated and the services which will be supported and offered. The tasks involved in building searchable databases are well understood by those of skill in the art, and need not be further elaborated upon. In a preferred embodiment, searchable subgraphs are stored in a searchable subgraph database (not shown) contained in memory 124.

It is contemplated that performing all of the above steps, from conversion through generation of searchable subgraphs, may require significant processing power and take considerable time. Therefore, in a preferred embodiment, these steps are performed in batch. It is possible, however, that it will become necessary after completion of these steps to discern information which cannot be extracted or deduced from the subgraphs created. For this reason, it is desirable to provide support for real time searches of both the normalized database and the subgraph database. It may also be desirable to support real-time subgraph generation.

In a preferred embodiment, a database front end (“DBFE”) is employed (not shown) for user interaction with the searchable subgraph database. The DBFE should provide an easy to use and intuitive user interface for querying the searchable subgraph database, and should have sufficient intelligence to process the results of database searches and to present those results to the user in an easy to understand format.

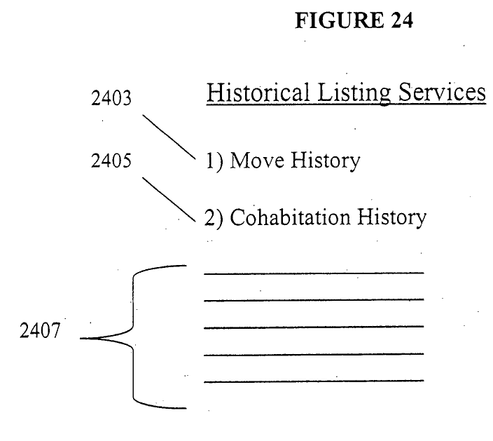

For example, suppose move and cohabitation subgraphs have been generated as described above, and that one of the subgraphs which has been generated and stored is the subgraph illustrated in FIG. 23 (and drawn in FIG. 22D). Obviously, users cannot be required to know the search language of the database used to store the subgraph of FIG. 23 in order to retrieve move or cohabitation information. Moreover, search results provided in the form of raw data such as the data shown in FIG. 23 would be difficult to understand. The DBFE addresses both of these issues. One example of a user interface which can be provided by a DBFE is illustrated in FIG. 24.

FIG. 24 depicts a user interface for selecting among the historical listing services provided by an information assistance provider in accordance with one preferred embodiment. As described above, the services which can be offered are a function of the subgraphs which have been generated. In the embodiment of FIG. 24, a move history service is offered which can be accessed with move history menu item 2403, and a cohabitation history service is offered which can be accessed with cohabitation history menu item 2405. Other menu items are represented generically by lines 2407 in FIG. 24, from which other services can be offered with use of the subgraph of FIG. 23 and/or other subgraphs which have been generated. The user interface may be utilized by operators at an information assistance center to retrieve information required by subscribers, or in some embodiments it may be utilized by the subscribers themselves over a network such as the Internet.

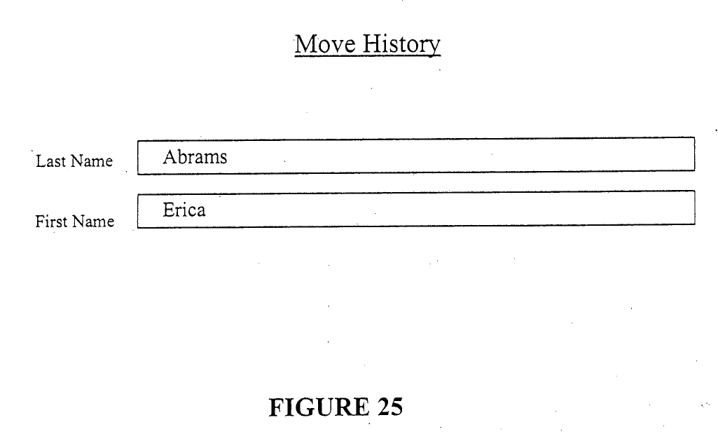

If an operator (or a subscriber) selects option 1 from FIG. 24, he may be presented with an interface such as that shown in FIG. 25, where the first and last names of the individual whose move history is desired can be entered. Those skilled in the art will appreciate that there are many ways to enter or select such a name, that search criteria other than or in addition to first and last name can be utilized, and that searches can be done for entities other than natural persons. In the example of FIG. 25, however, the operator requests the move history of Erica Abrams.

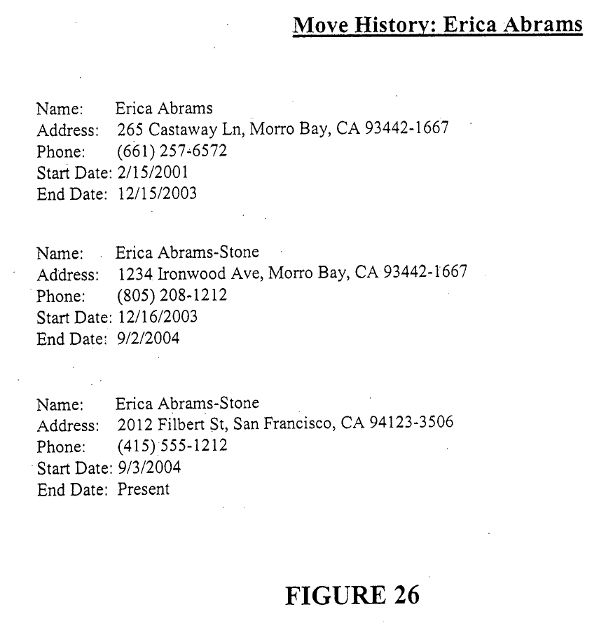

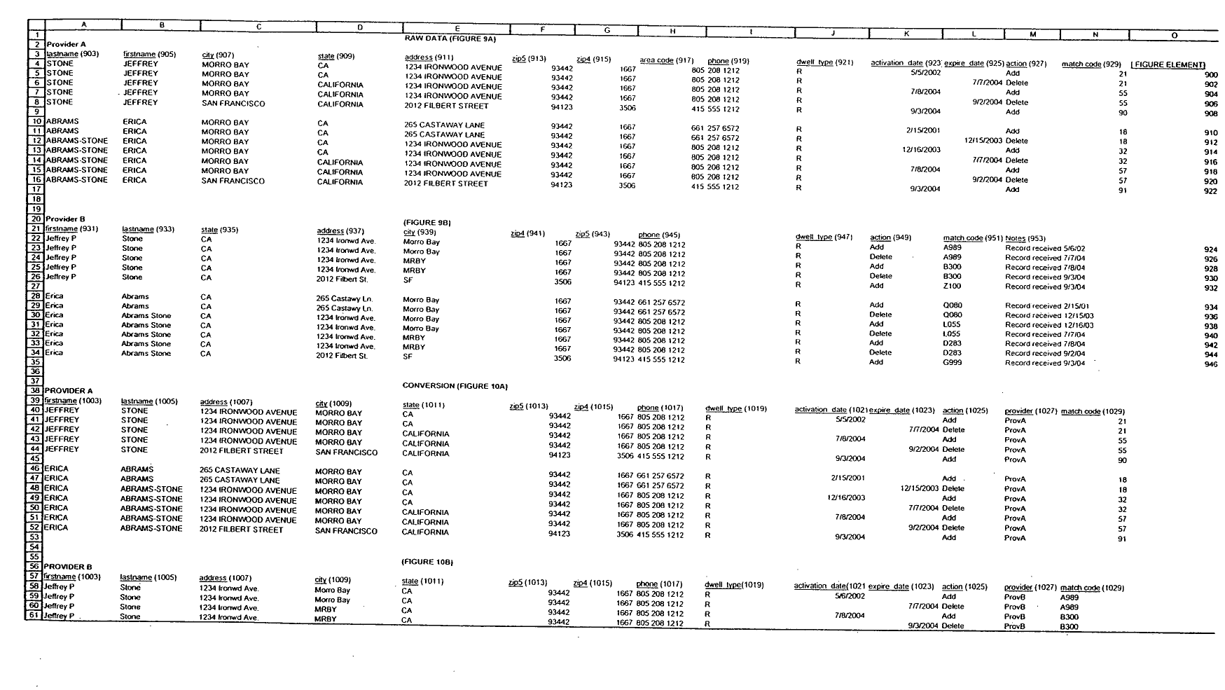

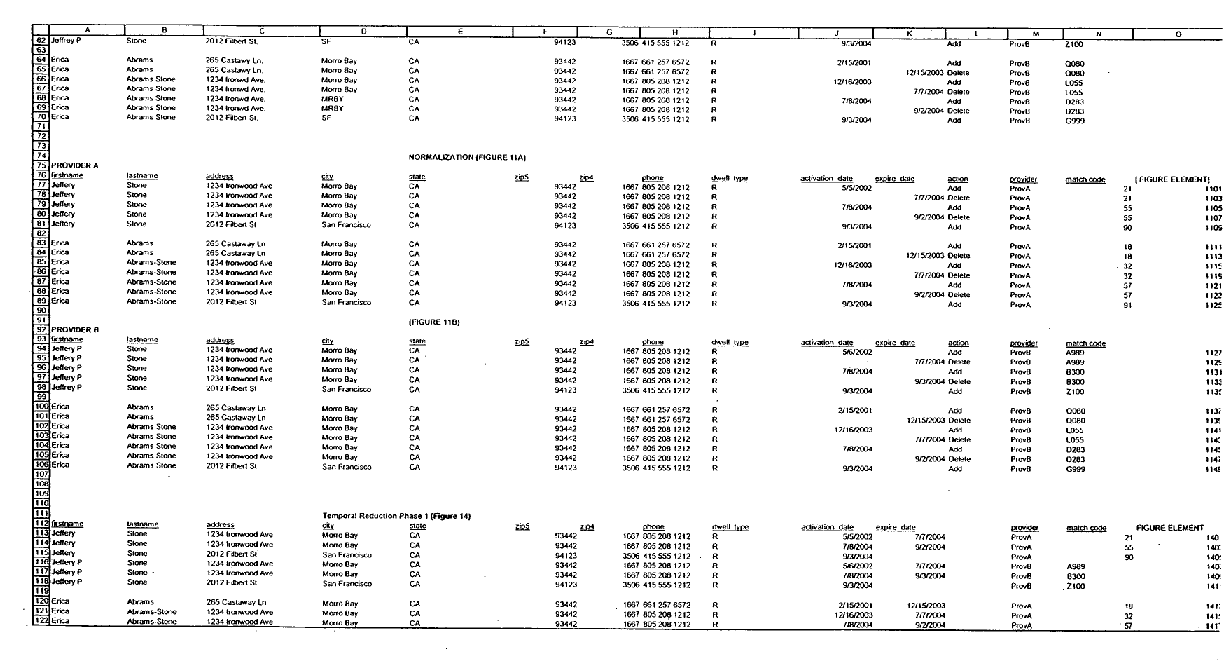

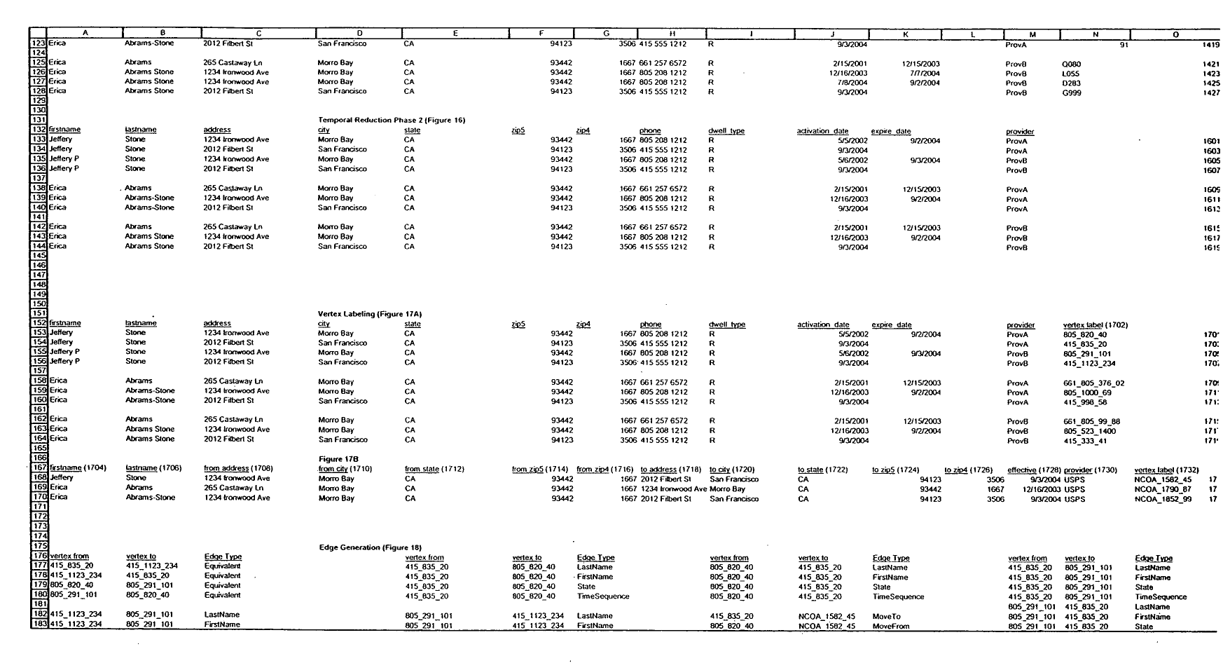

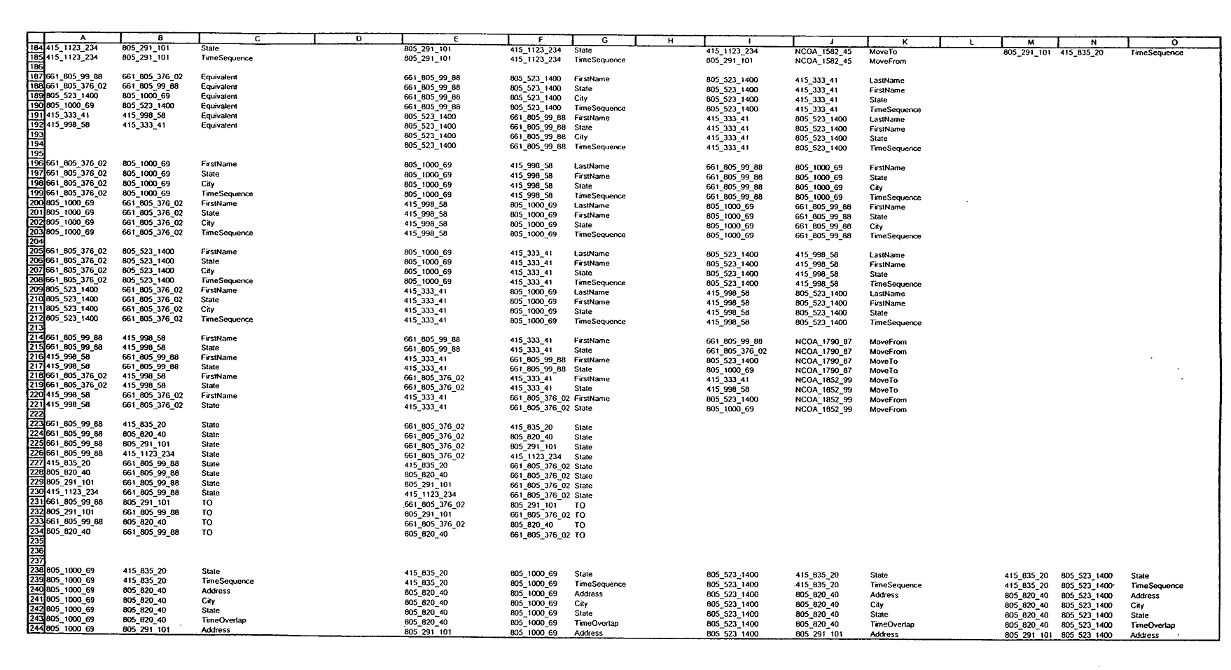

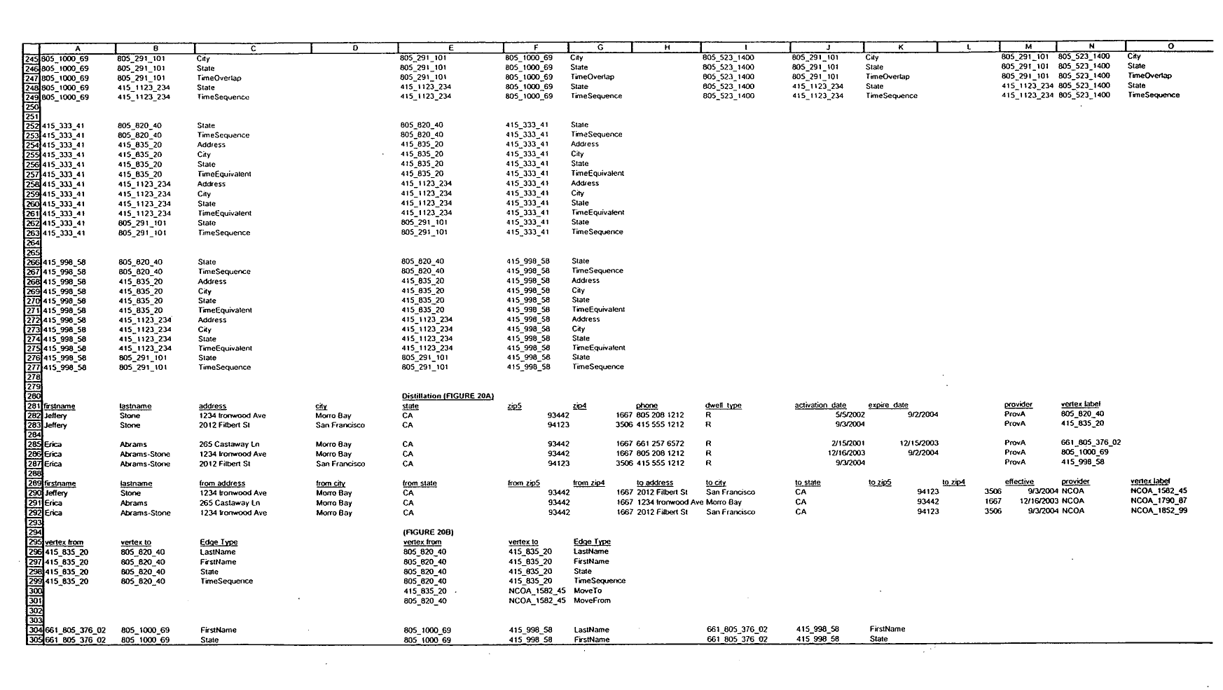

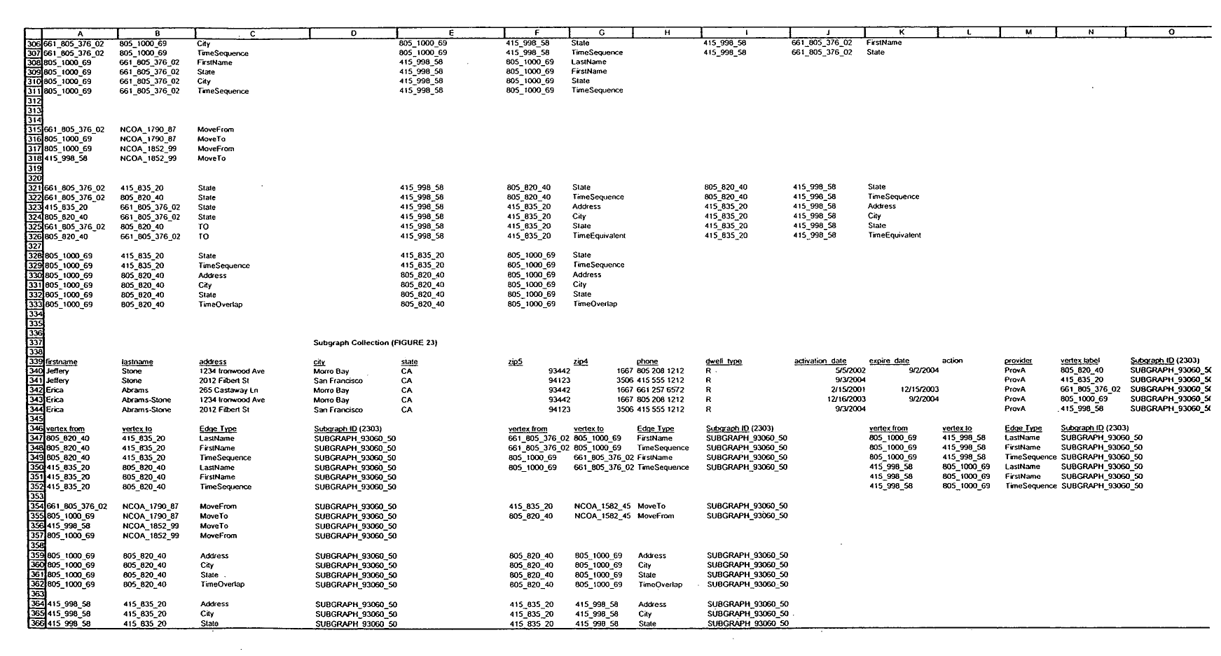

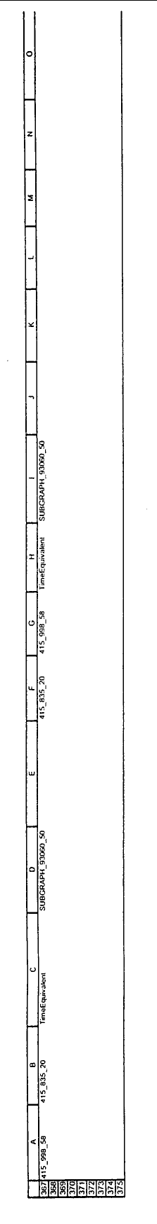

FIG. 26 depicts the results of the search as they are presented to the operator by a DBFE. In order to generate these results, the DBFE has traversed and processed the subgraph of FIG. 23 in order extract the Erica Abrams vertices, and has formatted and displayed the data in the vertices in a clear and easily understandable form. In other embodiments, discrete subgraphs would be generated for move history and cohabitation history in order to reduce or eliminate the subgraph traversal which must be done by the DBFE.

The DBFE can also contain rules for making intelligent deductions based on information contained in subgraphs. For example, it may be that none of the generated subgraphs contain vertices containing marital status information (e.g., because such information was not provided by data providers, vertices were not formed with such information, etc.), and no “marital status” subgraphs have been generated. The DBFE may contain rules however, to deduce martial status based on information that is available. For example, the DBFE may contain rules by which it will conclude that if a man and a woman live together, have the same last name, and the woman's name has been changed to include that of the man's (e.g., there is an earlier directory listing in which the same woman had a different last name), then the man and woman are married. In the subgraph of FIG. 22D and FIG. 23, then, the DBFE would determine that Erica Abrams-Stone and Jeffrey Stone are married. In some embodiments, rules can also be included to report such deductions with an assigned level of confidence.

The above presents various principles and features of the invention through descriptions of various embodiments. It is understood that skilled artisans can make various changes and modifications to the embodiments without departing from the spirit and scope of this invention.

What is claimed is:

1. A method of gathering information using directory listings, the method comprising:
(a) forming a plurality of vertices, wherein at least two of the vertices contain information from at least one of the directory listings;
(b) generating edges between the vertices to form a graph, wherein each of the edges contain information about a relationship between a pair of vertices connected by each respective edge; and
(c) employing at least one rule to traverse the graph to extract desired information.

2. The method of claim 1, wherein at least two of the vertices comprise name information.

3. The method of claim 2, wherein at least two of the vertices comprise address information.

4. The method of claim 3, wherein at least two of the vertices comprise telephone number information.

5. The method of claim 4, wherein at least two of the vertices comprise information related to one or more of the following: when the directory listing was active, Do Not Call numbers, National Change of Address information, credit reporting information, Telephone Company information, demographic information, move to information and move from information.

6. The method of claim 1, wherein at least two of the vertices comprise information related to one or more of the following: when the directory listing was active, Do Not Call numbers, National Change of Address information, credit reporting information, Telephone Company information, demographic information, move to information and move from information.

7. The method of claim 1, wherein at least two of the vertices comprise address number information.

8. The method of claim 1, wherein at least two of the vertices comprise telephone number information.

9. The method of claim 1, wherein forming a plurality of vertices comprises converting listings received from a plurality of directory listing providers into a uniform nomenclature.

10. The method of claim 9, wherein forming a plurality of vertices comprises combining add listings with their corresponding delete listings.

11. The method of claim 10, wherein forming a plurality of vertices comprises combining listings having only nomenclature differences.

12. The method of claim 1, wherein forming a plurality of vertices comprises combining add listings with their corresponding delete listings.

13. The method of claim 12, wherein forming a plurality of vertices comprises combining listings having only nomenclature differences.

14. The method of claim 1, wherein forming a plurality of vertices comprises combining listings having only nomenclature differences.
The method of claim 1, wherein the edges comprise one or more of the following edge types: a Last Name edge type, a First Name edge type, a City edge type, a State edge type, an Address edge type, a Zip-5 edge type, a Zip-4 edge type, a Telephone Number edge type, a Time Sequence edge type, a Time Overlap edge type, a Time Equivalence edge type, a move from edge type, a move to edge type and an Equivalent edge type.

15. The method of claim 1, comprising:
employing at least one rule to traverse the graph to create a subgraph containing vertices having desired relationships.

16. A method of gathering information using directory listings, the method comprising:
normalizing data records corresponding to the directory listings;
forming a plurality of vertices between normalized data records;
generating edges between vertices to form a graph, wherein each of the edges contain information about a relationship between a pair of vertices connected by each respective edge; and
employing at least one rule to traverse the graph, to extract desired information from the subgraph.

17. The method of claim 16, comprising:
normalizing the information by converting information into a uniform nomenclature.

18. The method of claim 16, wherein the information from each directory listing is provided in a plurity of data information fields, the method comprising:
normalizing the information by defining substitution patterns for different fields.

19. The method of claim 18, wherein:
the substitution rules depend on a context of the information.

20. The method of claim 19, wherein:
the context is one or more of the following: information contained in another field for the same listing, a field in another listing from the same provider, a field in another listing from other providers, information not contained in any listings, and the data provider of the listing.

21. The method of claim 16, comprising normalizing one or more of the following:
name nomenclature, state name nomenclature, city name nomenclature, address nomenclature, and telephone nomenclature.

22. The method of claim 16, further comprising:
grouping data records into potentially equivalent records;
identifying actually equivalent records; and
using data fields in the identified actually equivalent records to form final records for each listing.

23. The method of claim 16, further comprising:
checking the normalized data records for validity.

24. The method of claim 23, further comprising:
checking the normalized data records for accuracy.

25. The method of claim 16, further comprising:
checking the normalized data records for accuracy.

26. The method of claim 16, further comprising:
identifying when a listing became active and when it expired; and
confirming the identified information into a single data record.

27. The method of claim 16, further comprising:
removing equivalent vertices from the graph.

28. The method of claim 16, further comprising:
removing one or more of the following from data records: suffixes of names, prefixes of names, white spaces and street name ordinances; and
using an algorithm to determine whether corresponding words are sound-equivalent.

29. The method of claim 16, comprising:
employing at least one rule to traverse the graph to create a subgraph containing vertices having desired relationships.

30. A method of gathering information using directory listings comprising:
identifying potentially equivalent data records among a plurality of first data records corresponding to a plurality of directory listings;
forming second data records from the actually equivalent first data records;
forming a plurality of vertices between non-equivalent first data records and the second data records;
generating edges between vertices to form a graph, wherein each of the edges contain information about a relationship between a pair of vertices connected by each respective edge; and
employing at least one rule to traverse the graph to extract desired information.

31. The method of claim 30, wherein data records comprise data fields, the method further comprising:
identifying, for each data field in equivalent data records, a highest ranked data field of all corresponding data fields; and
selecting data in the highest ranked data field to form the second data record.

32. The method of claim 31, further comprising:
ranking data providers for reliability for each data field.

33. The method of claim 30, comprising:
assigning confidence level values to potentially equivalent data records to determine if the potentially equivalent data records are actually equivalent data records.

34. The method of claim 30, further comprising:
removing one or more of the following from data records: suffixes of names, prefixes of names, white spaces and street name ordinances; and
using an algorithm to determine whether corresponding words are sound-equivalent.

35. The method of claim 30, further comprising:
normalizing data records; and
identifying potentially equivalent normalized data records.

36. The method of claim 30, further comprising:
removing equivalent vertices; and
generating edges between non-equivalent vertices.

37. The method of claim 30, comprising:
employing at least one rule to traverse the graph to create a subgraph containing vertices having desired relationships.

38. A method of gathering information utilizing directory listings, the method comprising:
temporally reducing data records corresponding to directory listings;
forming a plurality of vertices, wherein at least two of the vertices contain information from at least one of the temporally reduced data records;
generating edges between said vertices to form a graph, each of the edges containing information about the relationship between vertices connected by the respective edge; and
employing rules to traverse the graph to extract desired information.

39. The method of claim 38, further comprising:
temporally reducing the data records to identify when a listing became active and when the listing expired; and
combining the identified information into a single data record.

40. The method of claim 38, further comprising:
normalizing data records corresponding to directory listings, prior to temporally reducing the data records.

41. The method of claim 38, further comprising:
identifying potentially equivalent data records prior to forming the plurality of vertices;
forming second data records from the equivalent data records; and
temporally reducing the second data records.

42. The method of claim 38, further comprising:
removing equivalent vertices.

43. The method of claim 30, comprising:
employing at least one rule to traverse the graph to create a subgraph containing vertices having desired relationships.

44. A method of gathering information utilizing directory listings, the method comprising:
forming a plurality of vertices, wherein at least two of the vertices contain information from at least one of the directory listings;
generating edges between said vertices to form a graph, each of the edges containing information about the relationship between the vertices it connects;
distilling the graph to remove equivalent vertices; and
employing rules to traverse the graph to extract desired information.

45. The method of claim 44, wherein distilling the graph comprises:
identifying vertices representing listings received from different data providers and containing the same information; and
using one vertex to represent the information.

46. The method of claim 44, wherein distilling the graph comprises:
identifying equivalent vertices by identifying equivalent edges.

47. The method of claim 44, comprising:
removing equivalent vertices by favoring information provided by one data provider over another.

48. The method of claim 44, further comprising:
normalizing the data records.

49. The method of claim 44, further comprising:
identifying potentially equivalent data records; and
forming second data records from the equivalent data records.

50. The method of claim 44, further comprising:
identifying when a listing became active and when it expired; and
combining the identified information into a single record.

51. The method of claim 44, comprising:
employing at least one rule to traverse the graph to create a subgraph containing vertices having desired relationships.

52. A method of gathering information using directory listings, the method comprising:
forming a plurality of vertices, wherein at least two of the vertices contain information from at least one of the directory listings;
generating edges between the vertices to form a graph, wherein each of the edges contain information about a relationship between a pair of vertices connected by each respective edge; and
employing the at least one rule to generate at least one subgraph comprising vertices having desired relationships.

53. The method of claim 54, wherein:
the at least one rule is based, at least in part, on content of vertices, edges between vertices, or both.

54. The method of claim 52, wherein:
the at least one rule defines a confidence level of at least one edge; and
the at least one rule is dependent, at least in part, on the confidence level.

55. The method of claim 52, further comprising:
storing the subgraph in a searchable form in a database.

56. The method of claim 52, further comprising:
extracting information from the at least one subgraph; and
deducing information from the extracted information.

57. The method of claim 52, comprising:
applying rules based, at least in part, on the information to be extracted or deduced.

58. The method of claim 52, comprising:
applying a rule based, at least in part, on where an individual lived in the past, to verify identity.

59. The method of claim 52, comprising:
generating move history subgraphs.

60. The method of claim 59, wherein:
the move history subgraphs take into account name changes.

61. The method of claim 52, wherein:
the subgraph comprises multiple edge types.

62. The method of claim 52, further comprising:
deducing information based on available information.

63. The method of claim 52, further comprising:
normalizing the information.

64. The method of claim 52, further comprising:
identifying when a listing became active and when it expired; and
confirming the identified information into a single data record.

65. The method of claim 52, further comprising:
removing equivalent vertices from the graph.

66. A system for gathering information using directing listings, comprising;
means for forming a plurality of vertices, wherein at least two of the vertices contain information from at least one of the directory listings;
means for generating edges between the vertices to form a graph, each of the edges containing information about a relationship between the vertices connected by each respective edge; and
means for employing rules to traverse the graph to extract desired information.

67. A system for gathering information using directory listings, comprising;
memory; and
a processor coupled for the memory, the processor being programmed to:
form a plurality of vertices, wherein at least two of the vertices contain information from at least one of the directory listings;
generate edges between the vertices to form a graph, wherein each of the edges containing information about a relationship between the vertices connected by the respective edge; and
employ rules to traverse the graph to extract desired information;
wherein the rules are stored in the memory.

68. The system of claim 67, wherein the vertices comprise one or more of name information, telephone number information, information related to when the directory listing was active, information related to do Do Not Call numbers, National Change of Address information, credit reporting information, Telephone Company information, move to information, move from information and demographic information.

69. The system of claim 67, wherein the processor is programmed to form the plurality of vertices by converting listings received from a plurality of directory listing providers into a uniform nomenclature.

70. The system of claim 67, wherein the processor is programmed to form the plurality of vertices by combining add listings with their corresponding delete listings.

71. The system of claim 70, wherein the processor is programmed to form a plurality of vertices by combining listings having only nomenclature differences.

72. The system of claim 67, wherein the processor is programmed to form the plurality of vertices by combining add listings with their corresponding delete listings.

73. The system of claim 67, wherein the processor is programmed to form a plurality of vertices by combining listings having only nomenclature differences.

74. The system of claim 67, wherein the edges comprise one or more of a Last Name edge type, a First Name edge type, a City edge type, a State edge type, an Address edge type, a Zip-5 edge type, a Zip-4 edge type, a Telephone Number edge type, a Time Sequence edge type, a Time Overlap edge type, a Time Equivalence edge type, a Move To edge type, a Move From edge type and an Equivalent edge type.
